(19) United States
(12) Patent Application Publication
(10) Pub. No.: US 2024/0144382 A1
(43) Pub. Date: May 2, 2024

(54) LEANING-VEHICLE-TRAVELING-DATA-PROCESSING DEVICE

(71) Applicant: YAMAHA HATSUDOKI KABUSHIKI KAISHA, Iwata-shi (JP)

(72) Inventors: Keisuke MORISHIMA, Shizuoka (JP); Jian Hong LEE, Shizuoka (JP); Seigo NAGAYA, Shizuoka (JP)

(21) Appl. No.: 18/400,175

(22) Filed: Dec. 29, 2023

Related U.S. Application Data
(63) Continuation-in-part of application No. PCT/JP2022/026292, filed on Jun. 30, 2022.

(30) Foreign Application Priority Data
Jul. 7, 2021 (JP) 2021-112552

(51) Int. Cl. G06Q 40/08; G07C 5/04

(52) U.S. Cl. CPC G06Q 40/08; G07C 5/04

(57) ABSTRACT

A leaning-vehicle-traveling-data processing device including: a memory configured to store the leaning-vehicle-traveling data; and a processor configured to generate economic-loss-related data based on the stored leaning-vehicle-traveling data using an economic-loss-related-data-generation model. The economic-loss-related-data-generation model is configured to generate the economic-loss-related data in accordance with a sudden left or right leaning movement of a vehicle body based on data, included in the leaning-vehicle-traveling data, indicating left or right leaning movement of the vehicle body, such that first and second economic-loss-related data generated based respectively on first and second leaning-vehicle-traveling data, differ from each other, where the first and second leaning-vehicle-traveling data are obtained when a driver of the leaning vehicle travels a route during a time frame of a date without sudden acceleration/deceleration movement of the vehicle body in a front-rear direction, but respectively without and with the sudden left or right leaning movement of the vehicle body.

### CROSS-REFERENCES TO RELATED APPLICATIONS

This is a continuation-in-part application of International Application No. PCT/JP2022/026292, filed on Jun. 30, 2022, which claims foreign priority to Japan Patent Application No. 2021-112552, filed Jul. 7, 2021. The contents of the applications are incorporated herein by reference.

### TECHNICAL FIELD

The present teaching relates to a leaning-vehicle-traveling-data-processing device.

### BACKGROUND ART

A leaning-vehicle-traveling-data-processing device is known that generates and outputs economic-loss-related data based on leaning-vehicle-traveling data. For example, Patent Document 1 discloses an information processing device that detects driving behavior, which is the behavior of a driver or a moving object, and predicts risks based on the detection result of the driving behavior. Patent Document 1 discloses that the moving object includes, e.g., a motorcycle and a bicycle.

Patent Document 2 discloses a method and system for detecting vehicle events and classifying them based on vehicle information. The method disclosed in Patent Document 2 also includes comparing vehicle movement data with vehicle performance requirements for a plurality of insurance carrier plans and notifying a vehicle operator when vehicle traveling data satisfies the vehicle performance requirements for any one of the insurance carrier plans. Patent Document 2 discloses that the method and system can be used for other vehicles, such as motorcycles.

Patent Document 3 discloses an insurance system that determines insurance premiums based on inputted driving data. The driving data include, e.g., data on distance and driving behavior. The driving behavior includes at least one of course change, acceleration, or sudden acceleration. Patent Document 3 discloses that the vehicle may be, e.g., a motorcycle and a scooter.

### CITATION LIST

### Patent Document

Patent Document 1: International Patent Publication No. 2018/190152
Patent Document 2: U.S. Pat. No. 10,157,321
Patent Document 3: U.S. Pat. No. 10,817,950

### SUMMARY OF INVENTION

### Technical Problem

Leaning vehicles are used in various situations because of their high mobility and convenience. Thus, a leaning-vehicle-traveling-data-processing device for generating and outputting output-data specific to a leaning vehicle is required to generate and output output-data specific to a leaning vehicle in consideration of various traveling scenes. In particular, when the leaning-vehicle-traveling-data-processing device generates economic-loss-related data as the output-data, it is required to generate more accurate economic-loss-related data based on traveling data of the leaning vehicle.

When, in the leaning-vehicle-traveling-data-processing device, an attempt is made to obtain data on various conditions such as a traveling state for generation of more accurate economic-loss-related data, the number of types and amount of data to be processed by the leaning-vehicle-traveling-data-processing device become large. Thus, hardware load on the leaning-vehicle-traveling-data-processing device is significantly high. This increases hardware resources required by the leaning-vehicle-traveling-data-processing device, which places constraints on the design of hardware resources. Therefore, design flexibility of hardware resources in the leaning-vehicle-traveling-data-processing device is reduced.

It is an object of the present teaching to provide a leaning-vehicle-traveling-data-processing device that can enhance design flexibility of hardware resources, with increased accuracy of economic-loss-related data obtained based on leaning-vehicle-traveling data.

### Solution to Problem

The inventors of the present teaching have obtained the new findings described below through the study of output-data specific to leaning vehicles, which are based on traveling data of the leaning vehicles, and generated and output by the leaning-vehicle-traveling-data-processing devices.

Unlike a four-wheeled vehicle, a leaning vehicle leans to the right when turning to the right and leans to the left when turning to the left. Thus, when a driver causes a leaning vehicle to make a left turn or a right turn, the driver needs to lean the leaning vehicle downward for turning, and to raise the leaning vehicle after it has completed a turn. In addition, unlike a four-wheeled vehicle, a leaning vehicle changes course by leaning its vehicle body in the left direction or in the right direction. Moreover, the leaning vehicle has a smaller dimension in the left-right direction than the four-wheeled vehicle, and thus has greater flexibility in its traveling position in the left-right direction. Thus, course changes occur with high frequency in the case of the leaning vehicle.

In such a leaning vehicle, the driver's driving skill and driving tendency are likely to be shown in a sudden left or right leaning movement of the vehicle body when the leaning vehicle, e.g., changes course.

The inventors have also figured out that the sudden left or right leaning movement of the vehicle body, which is a movement reflecting the driver's driving skill and driving tendency as described above, is highly associated with economic-loss-related data. Thus, the inventors have found that a correlation between the driver operating the leaning vehicle and economic loss is easily obtained based on each type of data related to the sudden left or right leaning movement of the vehicle body reflecting the driver's driving skill and driving tendency as described above.

The course change refers to a movement of a leaning vehicle that changes course while traveling in the same direction. The course change also includes a movement of the leaning vehicle that changes lanes.

In light of the above, the inventors have found that, by processing leaning-vehicle-traveling data including the data related to the sudden left or right leaning movement of the vehicle body that reflects the driving skill and driving tendency of the driver of the leaning vehicle, output-data specific to the leaning vehicle that is usable, for example, for economic-loss-related services such as insurance and finance, can be accurately generated and then output.

The inventors have also found that, by using the above-described leaning-vehicle-traveling data for processing, the types of data to be processed can be limited compared with a case where leaning-vehicle-traveling data in all traveling scenes are processed. This suppresses an increase in the amount of data processed by the leaning-vehicle-traveling-data-processing device, which leads to reduced hardware load on the leaning-vehicle-traveling-data-processing device. Therefore, design flexibility of hardware resources of the leaning-vehicle-traveling-data-processing device can be enhanced.

As described above, the inventors have figured out that, by using the leaning-vehicle-traveling data including the data related to the sudden left or right leaning movement of the vehicle body that reflects the driving skill and driving tendency of the driver of the leaning vehicle for the processing, design flexibility of hardware resources can be enhanced with increased accuracy of the economic-loss-related data obtained based on the leaning-vehicle-traveling data, and thus arrived at the configuration as described below.

A leaning-vehicle-traveling-data-processing device according to one embodiment of the present teaching is configured to process leaning-vehicle-traveling data that is traveling data of a leaning vehicle configured to lean to left when turning to the left and lean to right when turning to the right, and includes: a non-transitory memory configured to store the leaning-vehicle-traveling data; and a processor configured to generate economic-loss-related data based on the leaning-vehicle-traveling data stored in the memory by using an economic-loss-related-data-generation model, to thereby output the generated economic-loss-related data, wherein the economic-loss-related-data-generation model is configured to generate the economic-loss-related data in accordance with data indicating a sudden movement of a vehicle body of the leaning vehicle included in the leaning-vehicle-traveling data. First leaning-vehicle-traveling data is obtained when a driver travels a first route on a first leaning vehicle during a first time frame of a first date without sudden acceleration or deceleration movement of the vehicle body in a front-rear direction of the leaning vehicle or the sudden left or right leaning movement of the vehicle body, second leaning-vehicle-traveling data is obtained when the driver travels the first route on the first leaning vehicle during the first time frame of the first date without the sudden acceleration or deceleration movement of the vehicle body in the front-rear direction, but with the sudden left or right leaning movement of the vehicle body, and the economic-loss-related-data-generation model is configured to generate the economic-loss-related data in accordance with the sudden left or right leaning movement of the vehicle body based on data indicating left or right leaning movements of the vehicle body included in the leaning-vehicle-traveling data so that first economic-loss-related data generated based on the first leaning-vehicle-traveling data and second economic-loss-related data generated based on the second leaning-vehicle-traveling data differ from each other.

It is thus possible to obtain, by using the economic-loss-related-data-generation model, the economic-loss-related data in accordance with the sudden left or right leaning movement of the vehicle body based on the data indicating left or right leaning movements of the vehicle body that are movements included in the leaning-vehicle-traveling data and reflecting a driving skill and driving tendency of the driver of the leaning vehicle.

The economic-loss-related-data-generation model is configured to generate the second economic-loss-related data obtained based on the second leaning-vehicle-traveling data and the first economic-loss-related data obtained based on the first leaning-vehicle-traveling data so as to differ from each other, where the second leaning-vehicle-traveling data is data obtained when a driver travels the first route with a sudden left or right leaning movement of the vehicle body, while the first leaning-vehicle-traveling data is data obtained when the driver travels the first route without a sudden left or right leaning movement of the vehicle body. Therefore, the economic-loss-related-data-generation model allows for generation of economic-loss-related data in accordance with the sudden left or right leaning movement of the vehicle body.

In the leaning vehicle, the driver's driving skill and driving tendency are likely to be shown in a sudden left or right leaning movement of the vehicle body. It is, therefore, possible to accurately obtain economic-loss-related data in accordance with the driver's driving skill and driving tendency, by generating the economic-loss-related data in accordance with the sudden left or right leaning movement of the vehicle body using the economic-loss-related-data-generation model as described above. Moreover, the levels of predictive driving of drivers differ according to the driving skills of the drivers of the leaning vehicle. Thus, the level of predictive driving of each driver is more likely to be shown in the sudden left or right leaning movement of the vehicle body. It is, therefore, possible to accurately obtain economic-loss-related data in accordance with the driver's level of predictive driving, by generating the economic-loss-related data in accordance with the sudden left or right leaning movement of the vehicle body as described above.

Furthermore, by using the data indicating left or right leaning movements of the vehicle body that are movements included in the leaning-vehicle-traveling data and reflecting the driving skill and driving tendency of the driver of the leaning vehicle, it is possible to suppress an increase in the amount of data to be processed, compared with a case where all leaning-vehicle-traveling data are used. This is conducive to reduction in hardware load on the leaning-vehicle-traveling-data-processing device. Therefore, design flexibility of hardware resources of the leaning-vehicle-traveling-data-processing device can be enhanced.

In the manner described above, it is possible to provide the leaning-vehicle-traveling-data-processing device that can enhance design flexibility of hardware resources, with increased accuracy of economic-loss-related data obtained based on leaning-vehicle-traveling data.

In another aspect, the leaning-vehicle-traveling-data-processing device according to the present teaching preferably includes the following configuration. The data that indicates the left or right leaning movement of the vehicle body, and that is used by the economic-loss-related-data-generation model to generate the economic-loss-related data, is for at least one driving cycle, wherein one driving cycle is a period of time during which a posture, and a speed in the front-rear direction, of the leaning vehicle change from a predetermined state and then return to the predetermined state, and each of the first leaning-vehicle-traveling data and the second leaning-vehicle-traveling data is for at least one driving cycle.

Thus, the leaning-vehicle-traveling data includes data for one driving cycle or more. It is therefore possible to generate, by using the economic-loss-related-data-generation model, economic-loss-related data in accordance with the sudden left or right leaning movement of the vehicle body, based on the data for one driving cycle or more that indicate the left or right leaning movements of the vehicle body and are included in the leaning-vehicle-traveling data, where the left or right leaning movement of the vehicle body reflects the driving skill and driving tendency of the driver of the leaning vehicle.

Moreover, the second leaning-vehicle-traveling data, which is obtained when the driver travels the first route with a sudden left or right leaning movement of the vehicle body, includes data for one driving cycle or more, while the first leaning-vehicle-traveling data, which is obtained when the driver travels the first route without a sudden left or right leaning movement of the vehicle body, includes data for one driving cycle or more. Therefore, by using the economic-loss-related-data-generation model configured such that the second economic-loss-related data obtained based on the second leaning-vehicle-traveling data differs from the first economic-loss-related data obtained based on the first leaning-vehicle-traveling data, economic-loss-related data can be more accurately generated in accordance with the sudden left or right leaning movement of the vehicle body.

Furthermore, the processor generates economic-loss-related data based on the data indicating the left or right leaning movements of the vehicle body in the leaning-vehicle-traveling data, which suppresses an increase in the amount of data to be processed, compared with a case where all leaning-vehicle-traveling data are used. This is conducive to reduction in hardware load on the leaning-vehicle-traveling-data-processing device. Therefore, design flexibility of hardware resources of the leaning-vehicle-traveling-data-processing device can be enhanced.

In the manner described above, it is possible to provide the leaning-vehicle-traveling-data-processing device that can enhance design flexibility of hardware resources, with increased accuracy of economic-loss-related data obtained based on leaning-vehicle-traveling data.

In another aspect, the leaning-vehicle-traveling-data-processing device according to the present teaching preferably includes the following configuration. Each of the first leaning-vehicle-traveling data and the second leaning-vehicle-traveling data includes at least data related to a roll motion of the vehicle body.

The first leaning-vehicle-traveling data and the second leaning-vehicle-traveling data thus include at least the data related to a roll motion, so that the first and second leaning-vehicle-traveling data include the data indicating the left or right leaning movements of the vehicle body. It is therefore possible to generate, by using the economic-loss-related-data-generation model, economic-loss-related data in accordance with the sudden left or right leaning movement of the vehicle body based on the data indicating the left or right leaning movements of the vehicle body that are movements included in the leaning-vehicle-traveling data and reflecting the driver's driving skill and driving tendency.

In another aspect, the leaning-vehicle-traveling-data-processing device according to the present teaching preferably includes the following configuration. During the sudden left or right leaning movement of the vehicle body, the data indicating the left or right leaning movement of the vehicle body included in the leaning-vehicle-traveling data is greater than a threshold value.

This allows the processor to easily determine the data indicating the sudden left or right leaning movement of the vehicle body among the data indicating the left or right leaning movements of the vehicle body included in the leaning-vehicle-traveling data. Therefore, the economic-loss-related-data-generation model can easily generate economic-loss-related data in accordance with the sudden left or right leaning movement of the vehicle body based on the data indicating the sudden left or right leaning movement of the vehicle body.

In another aspect, the leaning-vehicle-traveling-data-processing device according to the present teaching preferably includes the following configuration. The sudden left or right leaning movement of the vehicle body includes at least one of a sudden downward leaning for turning, a sudden rise, or a sudden course change, of the leaning vehicle.

The sudden downward leaning for turning, the sudden rise, and the sudden course change, of the leaning vehicle are likely to show differences in driving skill and driving tendency of drivers driving the leaning vehicle. In addition, the sudden downward leaning, the sudden rise, and the sudden course change, which reflect a driver's driving skill and driving tendency as described above, are highly associated with data related to economic loss. Therefore, a correlation between the driver driving the leaning vehicle and economic loss is easily obtained from data related to the sudden downward leaning, the sudden rise, and the sudden course change.

Therefore, economic-loss-related data can be accurately obtained based on the data related to the sudden downward leaning, the sudden rise, and the sudden course change in the leaning-vehicle-traveling data.

In another aspect, the leaning-vehicle-traveling-data-processing device according to the present teaching preferably includes the following configuration. The processor is further configured to generate turning evaluation data related to at least one of agility or smoothness of the leaning vehicle when turning, from the leaning-vehicle-traveling data. The memory is further configured to store the generated turning evaluation data. The economic-loss-related data is generated based on the leaning-vehicle-traveling data, as well as the generated turning evaluation data.

Economic-loss-related data is generated based on the leaning-vehicle-traveling data as well as the turning evaluation data related to at least one of agility or smoothness of the leaning vehicle when turning. The turning evaluation data is data reflecting the driving skill of the driver driving the leaning vehicle that affects the level of predictive driving of the driver. Furthermore, combining the agility and smoothness serves to determine the driver's driving tendency. Therefore, economic-loss-related data that better reflects the driving skill and driving tendency can be obtained by generating the economic-loss-related data based on the leaning-vehicle-traveling data and the turning evaluation data as described above. Accordingly, the leaning-vehicle-traveling-data-processing device can generate and output economic-loss-related data that more reliably reflects the driver's driving skill and driving tendency.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification specify the presence of stated features, steps, operations, elements, components, and/or their equivalents, but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention.

Embodiments of a leaning-vehicle-traveling-data-processing device according to the present teaching will be herein described.

In the following description, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the FIGS. or description below.

[Leaning Vehicle]

A leaning vehicle herein is a vehicle that turns in a leaning posture. Specifically, the leaning vehicle is a vehicle that leans leftward when turning to left and leans rightward when turning to right in a left-right direction of the vehicle. The leaning vehicle may be a single-passenger vehicle or a vehicle on which a plurality of passengers can ride. The leaning vehicle may have wheels or may be free of wheels. The leaning vehicle may have movable parts other than wheels, such as ski boards, for example. The leaning vehicle includes all the types of vehicles that turn in leaning postures, such as three-wheeled vehicles and four-wheeled vehicles as well as two-wheeled vehicles. That is, the leaning vehicle may have any number of wheels.

[Sudden Movement of Vehicle Body]

A sudden movement of a vehicle body herein refers to a movement of the vehicle body that is faster than a normal movement out of movements of the vehicle body. The movement of the vehicle body is determined to be a sudden movement in cases such as when a value related to the movement of the vehicle body is greater than or equal to a threshold value set for many drivers, when the value related to the movement of the vehicle body is a prominent value in data of the same driver, or when it is determined that there is a rapid data change by fitting the waveform of data related to the movement of the vehicle body. On the other hand, the movement of the vehicle body is determined to be a less sudden movement in cases such as when the value related to the movement of the vehicle body is lower than the threshold value set for many drivers, when the value related to the movement of the vehicle body is less prominent in the data of the same driver, or when it is determined that a data change is less rapid by fitting the waveform of the data related to the movement of the vehicle body.

[Left or Right Leaning Movement of Vehicle Body]

A left or right leaning movement of the vehicle body herein refers to a movement of a vehicle body in which a lean angle of the vehicle body leaning in the left direction or in the right direction is changing. That is, the left or right leaning movement of the vehicle body refers to a movement of the vehicle body in which a value related to a roll motion of the vehicle body is nonzero.

The left or right leaning movement of the vehicle body is a movement of the vehicle body that occurs when the leaning vehicle changes its direction of travel. For example, the left or right leaning movement of the vehicle body is a movement of the vehicle body that occurs when turning at a curve or intersection. For example, the left or right leaning movement of the vehicle body is a movement of the vehicle body that changes lanes or changing course within a lane. For example, the left or right leaning movement of the vehicle body is a movement of the vehicle body that continuously changes course when avoiding, e.g., a manhole cover or a stone. The left or right leaning movement of the vehicle body includes at least one of a sudden downward leaning for turning, a sudden rise after completing a turn, or a sudden course change.

A sudden left or right leaning movement of the vehicle body refers to, out of the left or right leaning movements of the vehicle body, a movement of the vehicle body in which the value related to a roll motion of the vehicle body is greater than or equal to a threshold value.

[Data Indicating Left or Right Leaning Movement of Vehicle Body]

Data indicating a left or right leaning movement of the vehicle body herein refers to data related to a roll motion of the vehicle body. The data indicating a left or right leaning movement of the vehicle body may be, for example, data of a roll rate of the vehicle body, or data related to the roll motion other than the roll rate. The data related to the roll motion may include, for example, at least one of an angular acceleration of the vehicle body rotating about a roll axis (roll-axis angular acceleration), an angular acceleration of the vehicle body rotating about a yaw axis (yaw-axis angular acceleration), an acceleration in the left-right direction (pitch axis direction) (pitch axis acceleration), or a combination of a speed in a front-rear direction (roll axis direction) and a yaw rate. The roll axis is an axis extending in the front-rear direction with respect to the leaning vehicle. The pitch axis is an axis extending in the left-right direction with respect to the leaning vehicle. The yaw axis is an axis extending vertically with respect to the leaning vehicle. The roll-axis angular acceleration is a time derivative value of the roll rate. The yaw-axis angular acceleration is a time derivative value of the yaw rate.

[Sudden Downward Leaning for Turning]

A sudden downward leaning for turning herein refers to a leaning movement of the vehicle body in which a time derivative value of a roll rate when a driver leans the vehicle body to the left at left turning of the leaning vehicle, or a time derivative value of a roll rate when the driver leans the vehicle body to the right at right turning of the leaning vehicle, is greater than or equal to a first sudden-turn threshold value. The sudden downward leaning for turning may be determined using a value related to the roll rate, other than the time derivative value of the roll rate. The sudden downward leaning for turning may be determined using, for example, a value related to a yaw rate.

[Sudden Rise after Completing Turn]

A sudden rise after completing a turn herein refers to a leaning movement of the vehicle body in which a time derivative value of the roll rate when a driver raises the vehicle body after a left turn or a right turn of the leaning vehicle is greater than or equal to a second sudden-turn threshold value. The sudden rise after completing a turn may be determined using a value related to the roll rate, other than the time derivative value of the roll rate. The sudden rise after completing a turn may be determined using, for example, a value related to the yaw rate.

[Sudden Course Change]

A sudden course change herein refers to, out of course changes of the leaning vehicle, a course change in which the roll rate is greater than or equal to a threshold value. The course change refers to a movement of the leaning vehicle that changes course while traveling in the same direction. The course change also includes a movement of the leaning vehicle that changes lanes. The sudden course change may refer to a movement of the leaning vehicle when the difference between peak values of the roll-axis angular acceleration at both the times of a downward leaning and a rise of the vehicle body is greater than or equal to a threshold value. The sudden course change may be determined using a value other than the roll rate, as long as it is determined using a value related to the roll motion.

[Economic-Loss-Related Service]

Economic-loss-related services herein refer to services related to economic loss in, e.g., insurance, finance, rental, and assessment in a company. Specifically, the economic-loss-related services include, for example, services related to insurance, such as insurance rate setting support to automobile insurance companies; services related to finance, such as support for forecasting customer repayment risk to financial institutions; services related to passenger and transportation industries, such as employee assessment support to operating companies in, e.g., the passenger and transportation industries; services related to sharing or rental; services related to employee evaluation, such as corporate employee assessment support; and services related to business to business (B to B) transactions. The economic loss herein refers to economic loss, as well as includes economic benefit such as bonuses and incentives. That is, the economic loss refers to economic loss or benefit.

[Economic-Loss-Related Data]

Economic-loss-related data herein is data to be used for the economic-loss-related services described above. The economic-loss-related data includes, for example, data related to insurance rates, assessment results and repayment risk forecast results.

[Economic-Loss-Related-Data-Generation Model]

An economic-loss-related-data-generation model herein refers to a model for generating economic-loss-related data in accordance with a sudden movement of the vehicle body included in leaning-vehicle-traveling data. The economic-loss-related-data-generation model includes, e.g., logic, a learning model, a function, a model resulting from machine learning, and table data for generating economic-loss-related data based on at least a portion of the leaning-vehicle-traveling data.

[Generating Economic-Loss-Related Data in Accordance with Sudden Movement of Vehicle Body]

Generating economic-loss-related data based on a sudden movement of the vehicle body herein refers to generating economic-loss-related data through evaluation or analysis based on, e.g., the frequency of the sudden movements of the vehicle body per unit traveling distance and/or the degree of suddenness.

[Leaning-Vehicle-Traveling Data]

Leaning-vehicle-traveling data herein is data related to traveling of the leaning vehicle. The leaning-vehicle-traveling data includes data indicating a sudden movement of the vehicle body. A processor generates economic-loss-related data to be used for the economic-loss-related services in accordance with the data indicating a sudden movement of the vehicle body included in the leaning-vehicle-traveling data. The leaning-vehicle-traveling data may include data related to sudden acceleration or sudden deceleration of the leaning vehicle in the front-rear direction. The leaning-vehicle-traveling data may include at least one of leaning-vehicle-driving-input data related to a driving input to the leaning vehicle by a driver, leaning-vehicle-behavior data related to a behavior of the leaning vehicle, leaning-vehicle-location data related to a traveling location of the leaning vehicle, or leaning-vehicle-traveling-environment data related to a traveling environment of traveling of the leaning vehicle.

[First Leaning-Vehicle-Traveling Data]

First leaning-vehicle-traveling data herein refers to leaning-vehicle-traveling data that is free of data indicating a sudden left or right leaning movement of the vehicle body. The first leaning-vehicle-traveling data is data obtained when the leaning vehicle travels without a sudden left or right leaning movement of the vehicle body, in a case where, for example, the leaning vehicle makes a wide turn when turning at an intersection. In addition, the first leaning-vehicle-traveling data is data obtained when the leaning vehicle travels without a sudden left or right leaning movement of the vehicle body, in a case where, for example, the leaning vehicle changes course with a large margin in terms of distance or time when avoiding, e.g., a manhole cover or a stone.

[Second Leaning-Vehicle-Traveling Data]

Second leaning-vehicle-traveling data herein refers to leaning-vehicle-traveling data that is obtained when the leaning vehicle travels the same route as that traveled by the leaning vehicle in obtaining the first leaning-vehicle-traveling data, during the same time frame of the same date, and also includes data indicating a sudden left or right leaning movement of the vehicle body. The second leaning-vehicle-traveling data is data obtained when the leaning vehicle travels with a sudden left or right leaning movement of the vehicle body, in a case where, for example, the leaning vehicle makes a small turn when turning at an intersection. In addition, the second leaning-vehicle-traveling data is data obtained when the leaning vehicle travels with a sudden left or right leaning movement of the vehicle body, in a case where, for example, the leaning vehicle changes course without enough distance or time when avoiding, e.g., a manhole cover or a stone.

The first leaning-vehicle-traveling data and the second leaning-vehicle-traveling data are leaning-vehicle-traveling data that are obtained when the leaning vehicle travels the same route during the same time frame of the same date, without a sudden acceleration or deceleration movement of the vehicle body in the front-rear direction. The first leaning-vehicle-traveling data and the second leaning-vehicle-traveling data differ from each other in whether the leaning-vehicle-traveling data includes data indicating a sudden left or right leaning movement of the vehicle body.

[First Time Frame of First Date]

A first time frame of a first date herein means that a time frame and date when the leaning vehicle travels for acquiring the first leaning-vehicle-traveling data are the same as a time frame and date when the leaning vehicle travels for acquiring the second leaning-vehicle-traveling data. This is to match as closely as possible the travel conditions of the leaning vehicle when acquiring the first leaning-vehicle-traveling data with those when acquiring the second leaning-vehicle-traveling data. For example, the time frame before and after sunset is excluded from the same time frame described above. The same time frame is a range of time during which the same driver can drive the leaning vehicle. The time frame refers to a predetermined range of time on a time axis, including one hour and two hours, for example.

[First Route]

A first route herein means that a route traveled by the leaning vehicle when acquiring the first leaning-vehicle-traveling data is the same as a route traveled by the leaning vehicle when acquiring the second leaning-vehicle-traveling data. That is, the first route means that a road traveled by the leaning vehicle when acquiring the first leaning-vehicle-traveling data is the same as a road traveled by the leaning vehicle when acquiring the second leaning-vehicle-traveling data. This is to match as closely as possible the travel conditions of the leaning vehicle when acquiring the first leaning-vehicle-traveling data with those when acquiring the second leaning-vehicle-traveling data.

[One Driving Cycle]

One driving cycle herein refers to traveling of the leaning vehicle in a period of time during which a posture, and a speed in the front-rear direction, of the leaning vehicle change from a predetermined state and then return to the predetermined state. The one driving cycle may refer to, for example, traveling of the leaning vehicle in a period of time during which the leaning vehicle starts traveling from a stopped state and then comes to a stop. The posture of the leaning vehicle at each of the beginning and end of the one driving cycle may be in an upright state or in a leaning state. The speed of the leaning vehicle at each of the beginning and end of the one driving cycle may be zero or nonzero. The one driving cycle may be free of, e.g., left and right turns at intersections and cornering in curves. The leaning vehicle is smaller in size than other vehicles such as a four-wheeled vehicle, and has many opportunities to make small course changes even on straight roads. Therefore, even if data for the one driving cycle are free of, e.g., turning and cornering, the data are likely to show a movement other than straight traveling of the leaning vehicle.

[Agility]

Agility herein refers to a movement of the leaning vehicle when the leaning vehicle is traveling around a corner and an actual turning movement of the leaning vehicle corresponds to a turning movement predicted based on a driver's intention to draw a turning force of the leaning vehicle.

[Smoothness]

Smoothness herein refers to a movement of the leaning vehicle when the leaning vehicle is traveling around a corner and an actual turning movement of the leaning vehicle corresponds to a turning movement predicted based on a driver's intention.

### Advantageous Effects of Invention

According to one embodiment of the present teaching, it is possible to provide a leaning-vehicle-traveling-data-processing device that can enhance design flexibility of hardware resources, with increased accuracy of economic-loss-related data obtained based on leaning-vehicle-traveling data.

### BRIEF DESCRIPTION OF DRAWINGS

FIG. 1 is a view showing a schematic configuration of a leaning-vehicle-traveling-data-processing device according to a first embodiment of the present teaching.

FIG. 2 is a block diagram showing a schematic configuration of a processor of the leaning-vehicle-traveling-data-processing device according to the first embodiment.

FIG. 3 is a schematic view of an example of one driving cycle.

FIG. 4 is a view showing a schematic configuration of a leaning-vehicle-traveling-data-processing device according to a third embodiment.

FIG. 5 is a block diagram showing a schematic configuration of a processor of the leaning-vehicle-traveling-data-processing device according to the third embodiment.

FIG. 6 is a view showing an example of the change in acceleration of the leaning vehicle in a front-rear direction.

FIG. 7 is a view showing an example of the change in a roll rate and a time derivative value of the roll rate of the leaning vehicle before, during, and after turning of the leaning vehicle.

FIG. 8 is a view showing an example of the change in the roll rate of the leaning vehicle during traveling.

FIG. 9 is a view showing a schematic configuration of a leaning-vehicle-traveling-data-processing device according to a fourth embodiment.

FIG. 10 is a block diagram showing a schematic configuration of a processor of the leaning-vehicle-traveling-data-processing device according to the fourth embodiment.

### DESCRIPTION OF EMBODIMENT

Embodiments will be described hereinafter with reference to the drawings. The dimensions of components in the drawings do not strictly represent, e.g., actual dimensions of the components and dimensional proportions of the components.

### First Embodiment

(Leaning-Vehicle-Traveling-Data-Processing Device)

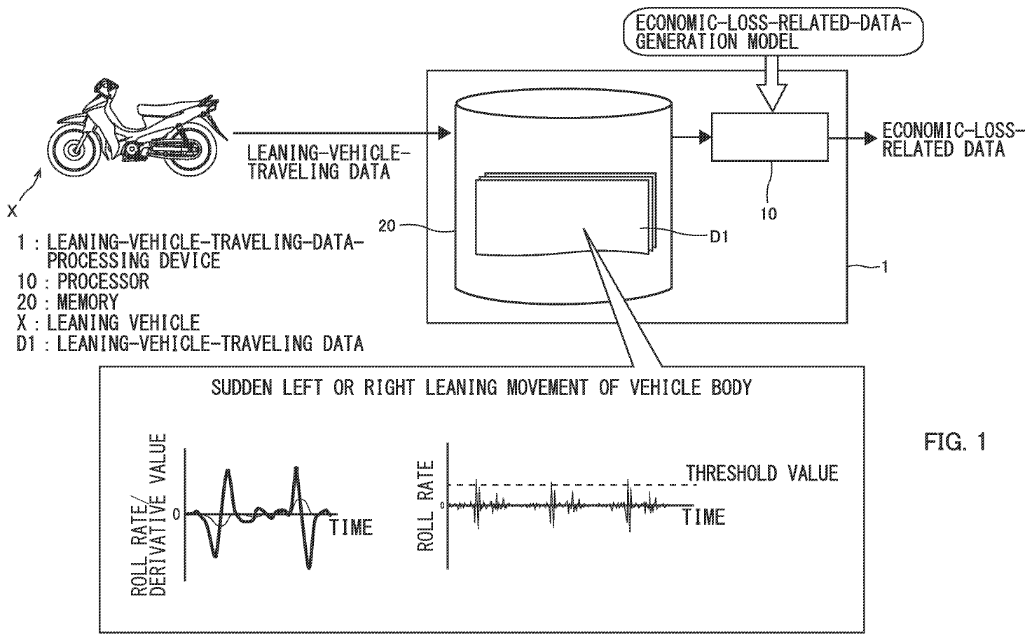

FIG. 1 shows a schematic configuration of a leaning-vehicle-traveling-data-processing device 1 according to a first embodiment of the present teaching. The leaning-vehicle-traveling-data-processing device 1 is a device for generating economic-loss-related data based on traveling data of a leaning vehicle X obtained when a driver drives the leaning vehicle X (leaning-vehicle-traveling data). The leaning-vehicle-traveling-data-processing device 1 may output the economic-loss-related data. When generating the economic-loss-related data based on the leaning-vehicle-traveling data, the leaning-vehicle-traveling-data-processing device 1 uses data indicating a left or right leaning movement of a vehicle body included in the leaning-vehicle-traveling data.

In this embodiment, the economic-loss-related data is generated in accordance with a sudden left or right leaning movement of the vehicle body. The economic-loss-related data is used for economic-loss-related services. The economic-loss-related services are services related to economic loss in, for example, insurance, finance, rental, and assessment in a company. Therefore, the economic-loss-related data is used, for example, for services related to insurance, services related to finance, services related to sharing and rental, services related to employee assessment in a company.

The leaning-vehicle-traveling data in this embodiment is data related to traveling of the leaning vehicle X. The leaning-vehicle-traveling data is used in generating the economic-loss-related data. The leaning-vehicle-traveling data includes data indicating a sudden left or right leaning movement of the vehicle body. The data indicating a sudden left or right leaning movement of the vehicle body are likely to show differences in driving skill and driving tendency of drivers of the leaning vehicle X. In addition, the driving skills affect differences in level of predictive driving of the drivers. Therefore, the data indicating a sudden left or right leaning movement of the vehicle body are likely to show differences in level of predictive driving of the drivers.

The left or right leaning movement of the vehicle body is a movement of the vehicle body in which a lean angle of the vehicle body leaning in the left direction or in the right direction is changing. That is, the left or right leaning movement of the vehicle body has a nonzero value related to a roll motion of the vehicle body.

The left or right leaning movement of the vehicle body is a movement of the vehicle body that occurs when the leaning vehicle changes its direction of travel. For example, the left or right leaning movement of the vehicle body is a movement of the vehicle body that occurs when turning at a curve or intersection. For example, the left or right leaning movement of the vehicle body is a movement of the vehicle body that occurs when changing lanes or changing course within a lane. For example, the left or right leaning movement of the vehicle body is a movement of the vehicle body that continuously changes course when avoiding, e.g., a manhole cover or a stone. The left or right leaning movement of the vehicle body includes at least one of a sudden downward leaning for turning, a sudden rise after completing a turn, or a sudden course change.

The sudden left or right leaning movement of the vehicle body is, for example, out of the left or right leaning movements of the vehicle body described above, a movement of the vehicle body in which a value related to a roll motion of the vehicle body is greater than or equal to a threshold value. In this case, the data indicating a left or right leaning movement of the vehicle body is data related to the roll motion of the vehicle body.

Therefore, the leaning-vehicle-traveling data includes, for example, at least one of data related to a sudden downward leaning for turning of the leaning vehicle X, data related to a sudden rise after the leaning vehicle has completed a turn, or data related to a sudden course change of the leaning vehicle.

Unlike a four-wheeled vehicle, the leaning vehicle leans to the right when turning to the right and leans to the left when turning to the left. Thus, when a driver causes the leaning vehicle to make a left turn or a right turn, the driver needs to lean the leaning vehicle downward for turning, and to raise the leaning vehicle after it has completed a turn. In such a leaning vehicle, differences in driving skill and driving tendency of drivers are likely to be shown in the actions of leaning the leaning vehicle downward for turning, and of raising the leaning vehicle after it has completed a turn. Therefore, the economic-loss-related data in accordance with the driving skill and driving tendency of a driver operating the leaning vehicle can be accurately obtained based on data related to the action of leaning the leaning vehicle downward for turning, and data related to the action of raising the leaning vehicle after it has completed a turn. Moreover, the differences in driving skill of drivers are likely to be shown in differences in level of predictive driving of the drivers. Therefore, the economic-loss-related data in accordance with the differences in level of predictive driving of the drivers can be obtained based on the respective types of data described above.

Unlike a four-wheeled vehicle, the leaning vehicle changes course by leaning its vehicle body in the left direction or in the right direction. Thus, the differences in driving skill and driving tendency of the drivers are likely to be shown in leaning states of the vehicle body when the leaning vehicle changes course. Therefore, the economic-loss-related data in accordance with the driving skill and driving tendency of the driver operating the leaning vehicle can be accurately obtained based on data related to course change of the leaning vehicle.

Furthermore, the leaning vehicle has a smaller dimension in the left-right direction than a four-wheeled vehicle, and thus has greater flexibility in its traveling position in the left-right direction. Thus, course changes occur with high frequency in the case of the leaning vehicle. Therefore, the differences in driving skill and driving tendency of the drivers are likely to be shown in the course changes of the leaning vehicle. Accordingly, the economic-loss-related data in accordance with the driving skill and driving tendency of the driver operating the leaning vehicle can be accurately obtained based on the data related to course change of the leaning vehicle.

Moreover, the differences in driving skill of the drivers are likely to be shown in the differences in level of predictive driving of the drivers as described above, so that the economic-loss-related data in accordance with the differences in level of predictive driving of the drivers can be obtained based on the data related to course changes described above.

The course change refers to a movement of the leaning vehicle that changes course while traveling in the same direction. The course change also includes a movement of the leaning vehicle that changes lanes.

The leaning-vehicle-traveling-data-processing device 1 includes a processor 10 and a memory 20. The leaning-vehicle-traveling-data-processing device 1 may be a portable terminal owned by a driver of the leaning vehicle X, or an arithmetic processing unit that acquires data through communication and performs a computation process. The arithmetic processing unit may be provided in the leaning vehicle or at a location other than the leaning vehicle.

The memory 20 may be a memory capable of temporary storage or a storage medium such as a hard disk. The memory 20 may have any configuration as long as it is capable of storing data acquired by the processor 10 or obtained through a computation process by the processor 10.

The memory 20 stores leaning-vehicle-traveling data when the driver drives the leaning vehicle X. In FIG. 1, the leaning-vehicle-traveling data stored in the memory 20 is denoted by D1. An economic-loss-related-data-generation model may be stored in the memory 20, or may be obtained by the processor 10 or another arithmetic unit based on the leaning-vehicle-traveling data accumulated in the memory 20.

The economic-loss-related-data-generation model is configured to generate economic-loss-related data to be used for the economic-loss-related services based on leaning-vehicle-traveling data obtained when the driver drives the leaning vehicle X. In detail, the economic-loss-related-data-generation model generates the economic-loss-related data in accordance with data indicating a sudden movement of the vehicle body included in the leaning-vehicle-traveling data.

In a case where first leaning-vehicle-traveling data is defined as leaning-vehicle-traveling data obtained when a driver travels a first route on a first leaning vehicle during a first time frame of a first date without a sudden acceleration or deceleration movement of the vehicle body in a front-rear direction or a sudden left or right leaning movement of the vehicle body, and second leaning-vehicle-traveling data is defined as leaning-vehicle-traveling data obtained when the driver travels the first route on the first leaning vehicle during the first time frame of the first date without the sudden acceleration or deceleration movement of the vehicle body in the front-rear direction, but with the sudden left or right leaning movement of the vehicle body, the economic-loss-related-data-generation model is configured to generate economic-loss-related data in accordance with the sudden left or right leaning movement of the vehicle body based on data indicating left or right leaning movements of the vehicle body included in the leaning-vehicle-traveling data so that first economic-loss-related data generated based on the first leaning-vehicle-traveling data and second economic-loss-related data generated based on the second leaning-vehicle-traveling data differ from each other.

The economic-loss-related-data-generation model includes logic, a learning model, a function, a model resulting from machine learning, and table data for generating economic-loss-related data based on at least a portion of the leaning-vehicle-traveling data.

If a change in the left or right leaning movement (e.g., roll rate) of the vehicle body is minute (e.g., a change due to measurement variations or errors), economic-loss-related data generated by the economic-loss-related-data-generation model may remain unchanged.

The processor 10 is an arithmetic processing unit used, for example, in a computer. The processor 10 may have the economic-loss-related-data-generation model. The processor 10 may read the economic-loss-related-data-generation model from the memory 20 or another storage device. The processor 10 may use the economic-loss-related-data-generation model obtained by the processor 10 or another arithmetic unit.

The processor 10 obtains leaning-vehicle-traveling data and stores the leaning-vehicle-traveling data in the memory 20, as well as generates economic-loss-related data by performing a computation process using the leaning-vehicle-traveling data stored in the memory 20 and the economic-loss-related-data-generation model. The processor 10 outputs the generated economic-loss-related data.

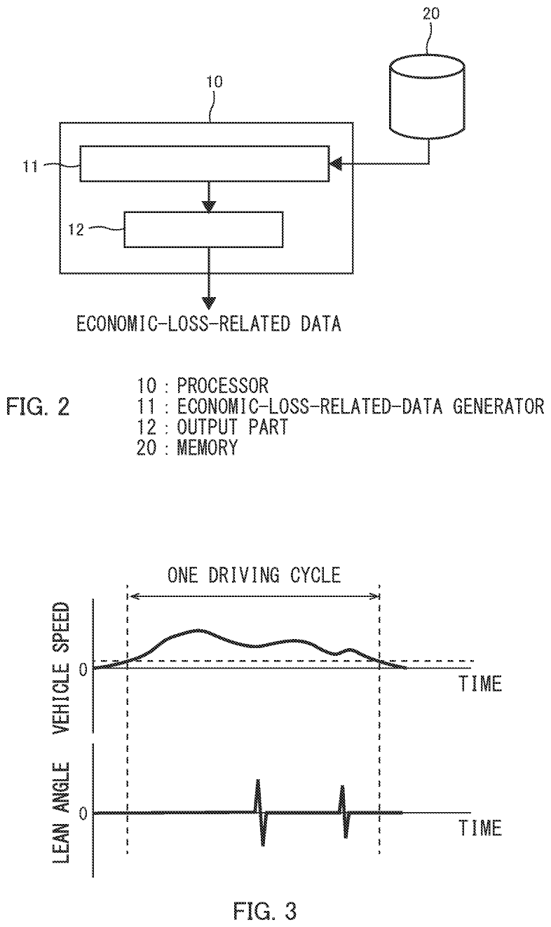

FIG. 2 is a block diagram showing a schematic configuration of the processor 10. As shown in FIG. 2, the processor 10 includes an economic-loss-related-data generator 11 and an output part 12.

The leaning-vehicle-traveling data to be stored in the memory 20 may be acquired, for example, by a sensor. The sensor includes, for example, an angle sensor including a gyro sensor, an acceleration sensor, a 6-axis inertial measurement unit (IMU), an image sensor, an infrared sensor, an ultrasonic sensor, and a position detection device such as GPS. The sensor may be any detection device as long as it is capable of acquiring the leaning-vehicle-traveling data described above.

The economic-loss-related-data generator 11 of the processor 10 generates economic-loss-related data using leaning-vehicle-traveling data including data indicating left or right leaning movements of the vehicle body and the economic-loss-related-data-generation model. The output part 12 of the processor 10 outputs the economic-loss-related data generated by the economic-loss-related-data generator 11.

As described above, the leaning-vehicle-traveling-data-processing device 1 of this embodiment includes the memory 20 for storing traveling data of the leaning vehicle X that leans to the left when turning to the left and leans to the right when turning to the right, as well as the processor 10 for generating economic-loss-related data based on the leaning-vehicle-traveling data stored in the memory 20, by using the economic-loss-related-data-generation model for generating the economic-loss-related data to be used for the economic-loss-related services in accordance with data indicating a sudden movement of the vehicle body included in the leaning-vehicle-traveling data, to thereby output the generated economic-loss-related data.

In the case where the first leaning-vehicle-traveling data is defined as leaning-vehicle-traveling data obtained when a driver travels the first route on the first leaning vehicle during the first time frame of the first date without a sudden acceleration or deceleration movement of the vehicle body in the front-rear direction or a sudden left or right leaning movement of the vehicle body, and the second leaning-vehicle-traveling data is defined as leaning-vehicle-traveling data obtained when the driver travels the first route on the first leaning vehicle during the first time frame of the first date without the sudden acceleration or deceleration movement of the vehicle body in the front-rear direction, but with the sudden left or right leaning movement of the vehicle body, the economic-loss-related-data-generation model is configured to generate economic-loss-related data in accordance with the sudden left or right leaning movement of the vehicle body based on data indicating left or right leaning movements of the vehicle body included in the leaning-vehicle-traveling data so that the first economic-loss-related data generated based on the first leaning-vehicle-traveling data and the second economic-loss-related data generated based on the second leaning-vehicle-traveling data differ from each other.

It is thus possible to obtain, by using the economic-loss-related-data-generation model, economic-loss-related data in accordance with a sudden left or right leaning movement of the vehicle body based on data indicating left or right leaning movements of the vehicle body that are movements included in leaning-vehicle-traveling data and reflecting a driving skill and driving tendency of the driver of the leaning vehicle.

The economic-loss-related-data-generation model is configured to generate the second economic-loss-related data obtained based on the second leaning-vehicle-traveling data and the first economic-loss-related data obtained based on the first leaning-vehicle-traveling data so as to differ from each other, where the second leaning-vehicle-traveling data is data obtained when a driver travels the first route with a sudden left or right leaning movement of the vehicle body, while the first leaning-vehicle-traveling data is data obtained when the driver travels the first route without a sudden left or right leaning movement of the vehicle body. Therefore, the economic-loss-related-data-generation model allows for generation of economic-loss-related data in accordance with the sudden left or right leaning movement of the vehicle body.

In the leaning vehicle X, the driver's driving skill and driving tendency are likely to be shown in a sudden left or right leaning movement of the vehicle body. It is, therefore, possible to accurately obtain economic-loss-related data in accordance with the driver's driving skill and driving tendency, by generating the economic-loss-related data in accordance with the sudden left or right leaning movement of the vehicle body using the economic-loss-related-data-generation model as described above.

Furthermore, by using data indicating left or right leaning movements of the vehicle body that are movements included in leaning-vehicle-traveling data and reflecting the driving skill and driving tendency of the driver of the leaning vehicle X, it is possible to suppress an increase in the amount of data to be processed, compared with a case where all leaning-vehicle-traveling data are used. This is conducive to reduction in hardware load on the leaning-vehicle-traveling-data-processing device. Therefore, design flexibility of hardware resources of the leaning-vehicle-traveling-data-processing device can be enhanced.

In the manner described above, it is possible to provide the leaning-vehicle-traveling-data-processing device 1 that can enhance design flexibility of hardware resources, with increased accuracy of economic-loss-related data obtained based on leaning-vehicle-traveling data.

### Second Embodiment

In this embodiment, leaning-vehicle-traveling data processed by the processor 10 of the leaning-vehicle-traveling-data-processing device 1 includes traveling data for one driving cycle or more of the leaning vehicle X. The leaning-vehicle-traveling data includes at least data related to a roll motion.

FIG. 3 is a view illustrating one driving cycle of the leaning vehicle X. As shown in FIG. 3, the one driving cycle refers to a travel period during which a posture, and a speed in the front-rear direction, of the leaning vehicle X change from a predetermined state and then return to the predetermined state. That is, the one driving cycle refers to a travel period during which the leaning vehicle X, which is in a predetermined posture and at a predetermined speed in the front-rear direction, changes its state and returns to the predetermined posture and the predetermined speed. The predetermined posture in the one driving cycle may be in an upright posture or in a leaning posture in the left direction or in the right direction. The predetermined speed in the one driving cycle may be zero (in a stopped state) or a traveling speed other than zero.

As described above, leaning-vehicle-traveling data includes at least data related to a roll motion. Thus, the leaning-vehicle-traveling data includes data indicating a left or right leaning movement of the vehicle body. It is, therefore, possible to generate, by using the economic-loss-related-data-generation mode, economic-loss-related data in accordance with a sudden left or right leaning movement of the vehicle body based on the data indicating the left or right leaning movements of the vehicle body that are movements included in the leaning-vehicle-traveling data and reflecting a driving skill and driving tendency of a driver of the leaning vehicle.

The data indicating the left or right leaning movement of the vehicle body may be, for example, data of a roll rate of the vehicle body, or data other than the roll rate, related to the roll motion.

The economic-loss-related-data-generation model is generated, for example, by machine learning, using training data and a feature as described below. Any form of machine learning may be used. The economic-loss-related-data-generation model may be generated by a method other than machine learning, as long as the method can generate the economic-loss-related-data-generation model.

The training data shows, for example, an association between leaning-vehicle-traveling data and economic loss. That is, the training data is, for example, data that associates leaning-vehicle-traveling data with economic-loss-related data.

The feature includes, for example, an operational-skill evaluation index, a traveling event index, a vehicle-behavior evaluation index, a traveling distance, a travel time, and a traveling environment index. The feature may include at least one of these indexes. The feature may be free of indexes other than the operational-skill evaluation index and the traveling event index.

The operational-skill evaluation index is an index related to evaluation of an operational skill. The operational-skill evaluation indexes are, for example, indexes related to smoothness and agility. These indexes are obtained based on an acceleration, an angular velocity, geomagnetism, and position information through, e.g., GPS.

The traveling event indexes are indexes related to, e.g., a sudden turn and emergency avoidance. These indexes are obtained based on an acceleration, an angular velocity, geomagnetism, and position information through, e.g., GPS.

The vehicle-behavior evaluation indexes are indexes related to an acceleration tendency, a road surface condition, and left-right variability, during straight traveling or turning. These indexes are obtained based on an acceleration, an angular velocity, geomagnetism, and position information through, e.g., GPS.

The traveling distance is obtained based on position information through, e.g., GPS. The travel time is obtained based on, e.g., time stamps.

The traveling environment indexes are indexes related to traveling environment, such as a temperature, a visible distance, a wind speed, a rainfall, and day or night. These indexes are obtained based on, e.g., weather information.

In this embodiment, when one driving cycle is defined as traveling of the leaning vehicle X in a period of time during which a posture, and a speed in the front-rear direction, of the leaning vehicle X change from a predetermined state and then return to the predetermined state, each of the first leaning-vehicle-traveling data and the second leaning-vehicle-traveling data includes data for one driving cycle or more. The economic-loss-related-data-generation model is preferably configured to generate economic-loss-related data in accordance with a sudden left or right leaning movement of the vehicle body, based on data for one driving cycle or more that indicate left or right leaning movements of the vehicle body and are included in the leaning-vehicle-traveling data so that the first economic-loss-related data generated based on the first leaning-vehicle-traveling data and the second economic-loss-related data generated based on the second leaning-vehicle-traveling data differ from each other.

Thus, the leaning-vehicle-traveling data includes data for one driving cycle or more. It is therefore possible to generate, by using the economic-loss-related-data-generation model, economic-loss-related data in accordance with a sudden left or right leaning movement of the vehicle body, based on data for one driving cycle or more that indicate left or right leaning movements of the vehicle body and are included in the leaning-vehicle-traveling data, where the left or right leaning movements of the vehicle body reflect a driving skill and driving tendency of a driver of the leaning vehicle X.

Moreover, the second leaning-vehicle-traveling data, which is obtained when the driver travels the first route with a sudden left or right leaning movement of the vehicle body, includes data for one driving cycle or more, while the first leaning-vehicle-traveling data, which is obtained when the driver travels the first route without a sudden left or right leaning movement of the vehicle body, includes data for one driving cycle or more. Therefore, by using the economic-loss-related-data-generation model configured such that the second economic-loss-related data obtained based on the second leaning-vehicle-traveling data differs from the first economic-loss-related data obtained based on the first leaning-vehicle-traveling data, economic-loss-related data can be more accurately generated in accordance with the sudden left or right leaning movement of the vehicle body.

Furthermore, the processor 10 generates economic-loss-related data based on data indicating left or right leaning movements of the vehicle body in leaning-vehicle-traveling data, which suppresses an increase in the amount of data to be processed, compared with a case where all leaning-vehicle-traveling data are used. This is conducive to reduction in hardware load on the leaning-vehicle-traveling-data-processing device. Therefore, design flexibility of hardware resources of the leaning-vehicle-traveling-data-processing device can be enhanced.

In the manner described above, it is possible to provide the leaning-vehicle-traveling-data-processing device that can enhance design flexibility of hardware resources, with increased accuracy of economic-loss-related data obtained based on leaning-vehicle-traveling data.

In this embodiment, the first leaning-vehicle-traveling data and the second leaning-vehicle-traveling data preferably include at least data related to a roll motion.

The first leaning-vehicle-traveling data and the second leaning-vehicle-traveling data thus include at least the data related to a roll motion, so that the first and second leaning-vehicle-traveling data include data indicating left or right leaning movements of the vehicle body. It is therefore possible to generate, by using the economic-loss-related-data-generation model, economic-loss-related data in accordance with a sudden left or right leaning movement of the vehicle body based on the data indicating the left or right leaning movements of the vehicle body that are movements included in the leaning-vehicle-traveling data and reflecting a driving skill and driving tendency of the driver of the leaning vehicle.

### Third Embodiment

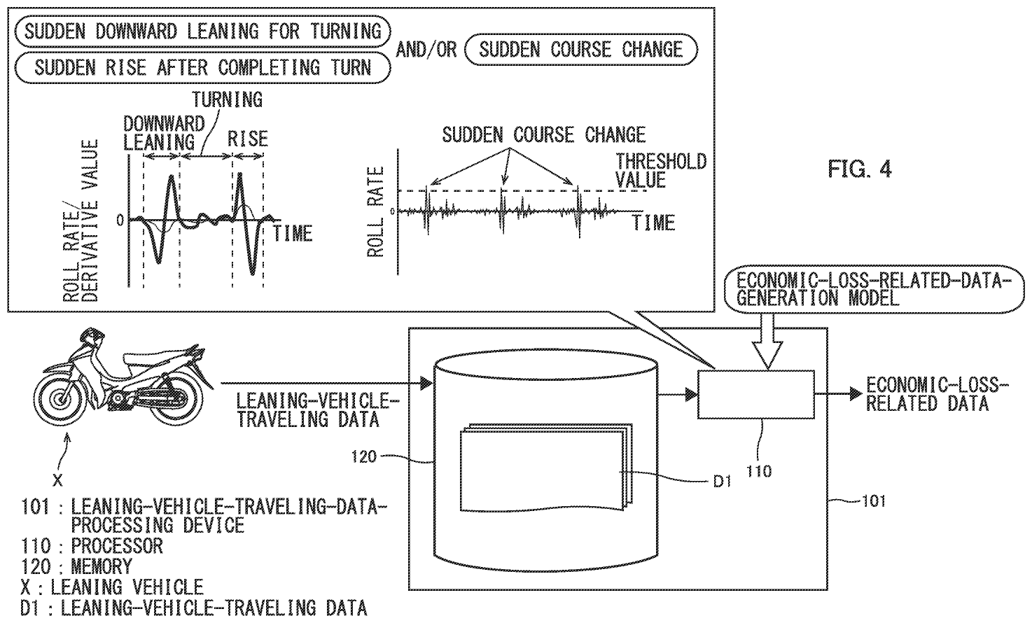

FIG. 4 is a view showing a schematic configuration of a leaning-vehicle-traveling-data-processing device 101 according to a third embodiment. The leaning-vehicle-traveling-data-processing device 101 of this embodiment analyzes a traveling scene of the leaning vehicle X based on leaning-vehicle-traveling data, and generates economic-loss-related data using the analysis results. In the following description, components similar to those of the first embodiment are denoted by the same reference characters and will not be described again, and only components different from those of the first embodiment will be described.

The leaning-vehicle-traveling data includes at least one of data related to a sudden downward leaning for turning of the leaning vehicle X, data related to a sudden rise after the leaning vehicle X has completed a turn, or data related to a sudden course change of the leaning vehicle X. The leaning-vehicle-traveling data may include data related to sudden acceleration of the leaning vehicle X or sudden deceleration of the leaning vehicle X.

The leaning-vehicle-traveling-data-processing device 101 includes a processor 110 and a memory 120.

The processor 110 analyzes traveling scenes of the leaning vehicle X based on leaning-vehicle-traveling data, and generates economic-loss-related data based on the economic-loss-related-data-generation model and the leaning-vehicle-traveling data in each traveling scene.

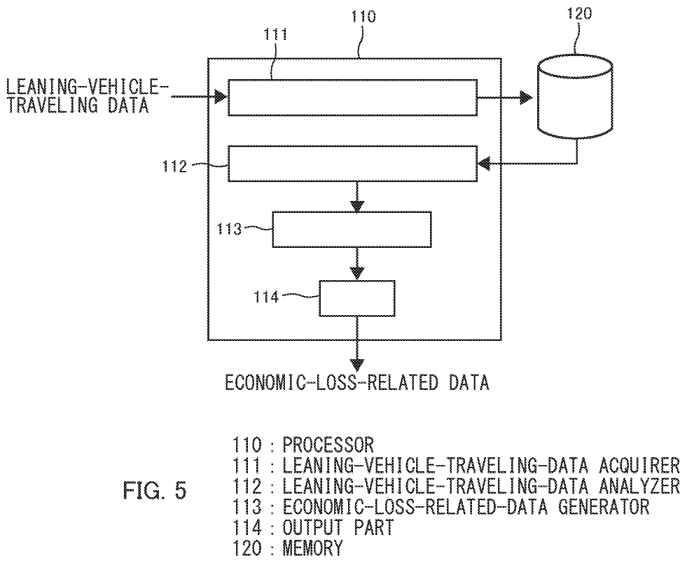

FIG. 5 is a block diagram showing a schematic configuration of the processor 110. As shown in FIG. 5, the processor 110 includes a leaning-vehicle-traveling-data acquirer 111, a leaning-vehicle-traveling-data analyzer 112, an economic-loss-related-data generator 113, and an output part 114.

The leaning-vehicle-traveling-data acquirer 111 acquires leaning-vehicle-traveling data from, e.g., an unillustrated sensor when a driver drives the leaning vehicle X, and stores the data in the memory 120.

The leaning-vehicle-traveling-data acquirer 111 may, for example, acquire an operation signal related to the driver's driving of the leaning vehicle X as the leaning-vehicle-driving-input data, and store the data in the memory 120. Specifically, the leaning-vehicle-traveling-data acquirer 111 may acquire data related to a driving input to the leaning vehicle X by the driver, i.e., data related to, e.g., an accelerator operation, a brake operation, steering, or a positional change of the center of gravity caused by a change in posture of the driver, as well as data related to, e.g., operations of various switches such as a horn switch, a winker switch, and a lighting switch, and then store the data in the memory 120. These data items are transmitted from the leaning vehicle X.

The leaning-vehicle-traveling-data acquirer 111 may acquire, for example, data including an acceleration, a speed, and an angle of the leaning vehicle X that change when the driver drives the leaning vehicle X, as leaning-vehicle-behavior data, and store the data in the memory 120. The processor 110 acquires the leaning-vehicle-behavior data by, e.g., a gyro sensor. The leaning-vehicle-behavior data is data showing a behavior of the leaning vehicle X occurring, e.g., when the driver performs an accelerator operation or a brake operation to accelerate or decelerate the leaning vehicle X, or when steering of the leaning vehicle X or a posture change including a positional change of the center of gravity is performed.

The leaning-vehicle-traveling-data acquirer 111 may acquire an operation occurring in the leaning vehicle X by, e.g., a switch operation performed on the leaning vehicle X by the driver, as the leaning-vehicle-behavior data, and store the data in the memory 120. That is, the leaning-vehicle-traveling-data acquirer 111 may acquire data related to an operation occurring in the leaning vehicle X by, e.g., operations of various switches such as a horn switch, a winker switch, and a lighting switch, as the leaning-vehicle-behavior data, and store the data in the memory 120. These data items are transmitted from the leaning vehicle X to the leaning-vehicle-traveling-data acquirer 111.

The leaning-vehicle-traveling-data acquirer 111 may acquire leaning-vehicle-location data related to a traveling location of the leaning vehicle X, based on, for example, information from a GPS or a communication base station of a communication mobile terminal, and store the data in the memory 120. The leaning-vehicle-location data can be obtained by, e.g., various positioning techniques and a SLAM.

The leaning-vehicle-traveling-data acquirer 111 may acquire leaning-vehicle-traveling-environment data from, for example, map data, and store the data in the memory 120. The map data may be associated with, for example, information on road situations, information on road traffic environments such as signals and facilities, and regulation information on traveling on roads. The map data may be associated with environmental data such as weather, temperature, and humidity. The map data may include information in which road information and information on road traffic environments (accompanying information to a road such as a signal) are associated with rule information on traveling on a road.

The leaning-vehicle-traveling-data acquirer 111 may acquire the leaning-vehicle-traveling-environment data by, for example, an external-environment-recognition device mounted on the leaning vehicle X, and store the data in the memory 120. More specifically, the leaning-vehicle-traveling-data acquirer 111 may acquire the leaning-vehicle-traveling-environment data from, e.g., a camera or a radar, and store the data in the memory 120. The processor 110 may also acquire the leaning-vehicle-traveling-environment data by, for example, a communication device, and store the data in the memory 120. More specifically, the leaning-vehicle-traveling-data acquirer 111 may acquire the leaning-vehicle-traveling-environment data by a vehicle-to-vehicle communication device or a road-to-vehicle communication device, and store the data in the memory 120. The processor 110 may acquire the leaning-vehicle-traveling-environment data through, for example, the Internet, and store the data in the memory 120. In this manner, the leaning-vehicle-traveling-environment data can be acquired by various configurations. The configuration for acquiring the leaning-vehicle-traveling-environment data is not limited to a specific configuration.

The leaning-vehicle-traveling-data analyzer 112 uses leaning-vehicle-traveling data to analyze at least one of the scene of a sudden downward leaning for turning, the scene of a sudden rise after completing a turn, or the scene of a sudden course change, of the leaning vehicle X. In detail, the leaning-vehicle-traveling-data analyzer 112 uses the leaning-vehicle-traveling data to analyze at least one scene described above for at least one of its frequency or degree. The leaning-vehicle-traveling-data analyzer 112 may analyze at least one of sudden deceleration or sudden acceleration of the leaning vehicle X.

The economic-loss-related-data generator 113 generates economic-loss-related data in the analyzed scene, using leaning-vehicle-traveling data including data indicating left or right leaning movements of the vehicle body and the economic-loss-related-data-generation model. The output part 114 outputs the economic-loss-related data generated by the economic-loss-related-data generator 113.

The configuration of the processor 110 other than that described above is similar to the configuration of the processor 10 in the first embodiment. The configuration of the memory 120 is similar to that of the memory 20 in the first embodiment.

(Analysis of Leaning-Vehicle-Traveling Data in Traveling Scene)

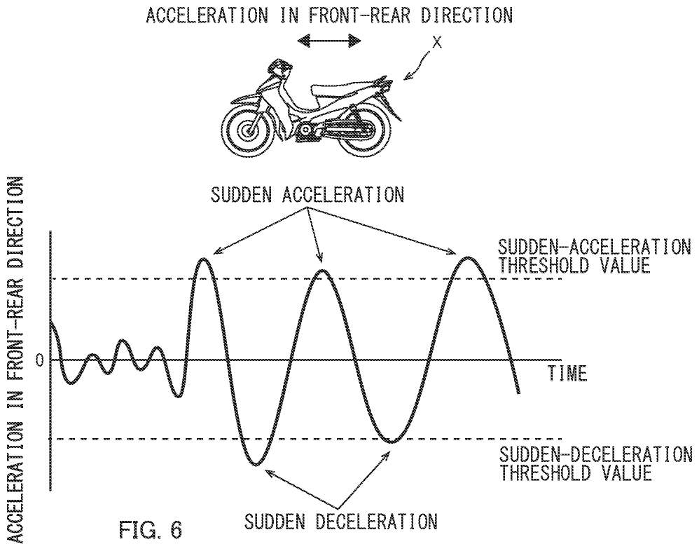

Analysis of leaning-vehicle-traveling data in a traveling scene of the leaning vehicle X by the processor 110 will now be described with reference to FIGS. 6 to 8. Sudden deceleration and sudden acceleration may be excluded from analysis of the processor 110.

1. Sudden Deceleration and Sudden Acceleration

The processor 110 determines sudden deceleration and sudden acceleration of the leaning vehicle X based on, for example, an acceleration of the leaning vehicle X in the front-rear direction. The processor 110 determines sudden deceleration and sudden acceleration of the leaning vehicle X using leaning-vehicle-traveling data D1 stored in the memory 120.

FIG. 6 shows an example of a change in acceleration of the leaning vehicle X in the front-rear direction. As shown in FIG. 6, the processor 110 determines that the leaning vehicle X has suddenly decelerated when the acceleration of the leaning vehicle X in the front-rear direction is a negative value, and less than or equal to a sudden-deceleration threshold value. The processor 110 determines that the leaning vehicle X has suddenly accelerated when the acceleration of the leaning vehicle X in the front-rear direction is a positive value, and greater than or equal to a sudden-acceleration threshold value. The sudden-deceleration threshold value and the sudden-acceleration threshold value are stored in the memory 120.

The determination results of sudden deceleration and sudden acceleration by the processor 110 as described above are stored in the memory 120 as data related to at least one of the frequency or degree. The frequency is, for example, the frequency of occurrence of sudden deceleration or sudden acceleration. The degree is, for example, the ratio of the magnitude of acceleration in the front-rear direction to the sudden-deceleration threshold value in the case of sudden deceleration, or the ratio of the magnitude of acceleration in the front-rear direction to the sudden-acceleration threshold value in the case of sudden acceleration.

2. Sudden Downward Leaning for Turning and Sudden Rise after Completing Turn

The processor 110 determines a sudden downward leaning for turning and a sudden rise after completing a turn in the leaning vehicle X based on, for example, a time derivative value of a roll rate. The processor 110 determines the sudden downward leaning for turning and the sudden rise after completing a turn in the leaning vehicle X using the leaning-vehicle-traveling data stored in the memory 120.

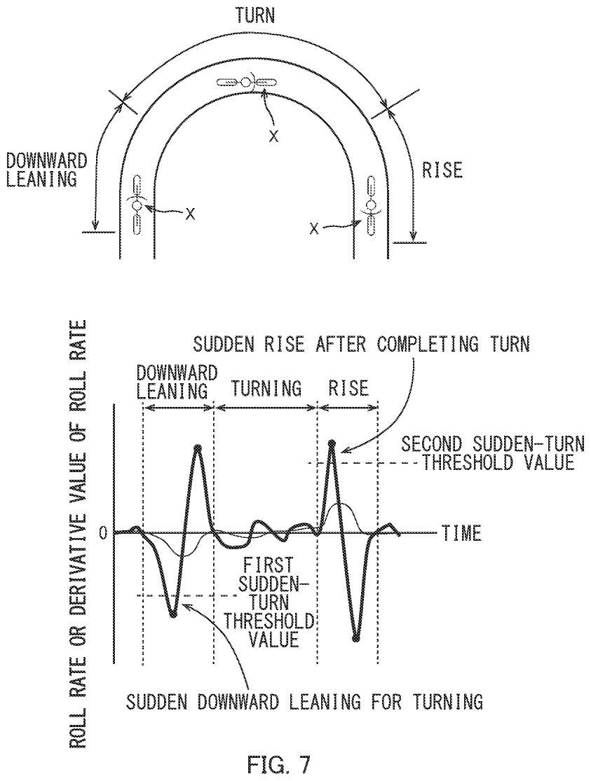

FIG. 7 is a view showing an example of a change in the roll rate and the time derivative value of the roll rate of the leaning vehicle X before a turn, during the turn, and after completing the turn of the leaning vehicle X. In FIG. 7, the roll rate is indicated by a thin line, and the time derivative value of the roll rate is indicated by a thick line. As shown in FIG. 7, there are peaks (black dots in the figure) in the time derivative value of the roll rate of the leaning vehicle X, before the turn and after completing the turn of the leaning vehicle X, respectively.

The processor 110 uses the peak of the time derivative value of the roll rate before the leaning vehicle X turns, to determine a sudden downward leaning for turning of the leaning vehicle X. Specifically, the processor 110 determines that the movement of the leaning vehicle X is a sudden downward leaning for turning of the leaning vehicle X when the peak of the time derivative value of the roll rate before the leaning vehicle X turns is greater than or equal to the first sudden-turn threshold value. The processor 110 may determine that the movement of the leaning vehicle X is a sudden downward leaning for turning of the leaning vehicle X when an average of the peaks of the time derivative value of the roll rate before the leaning vehicle X turns is greater than or equal to the first sudden-turn threshold value.

The processor 110 uses the peak of the time derivative value of the roll rate after the leaning vehicle X has completed the turn, to determine a sudden rise after completing the turn of the leaning vehicle X. Specifically, the processor 110 determines that the movement of the leaning vehicle X is a sudden rise after completing the turn of the leaning vehicle X when the peak of the time derivative value of the roll rate after the leaning vehicle X has completed the turn is greater than or equal to the second sudden-turn threshold value. The processor 110 may determine that the movement of the leaning vehicle X is a sudden rise after completing the turn of the leaning vehicle X when an average of the peaks of the time derivative value of the roll rate after the leaning vehicle X has completed the turn is greater than or equal to the second sudden-turn threshold value.

The processor 110 may use the peak of the time derivative value of the roll rate before the turn or after completing the turn, of the leaning vehicle X, to determine at least one of a sudden downward leaning for turning of the leaning vehicle X or a sudden rise after completing the turn of the leaning vehicle X. The processor 110 may use a yaw rate, a pitch axis acceleration, a yaw-axis angular acceleration, or a roll-axis angular acceleration in place of the roll rate to determine the sudden downward leaning for turning and the sudden rise after completing the turn. The processor 110 may determine a sudden turn when a difference between the peak values of the roll rate at both the times of a downward leaning and a rise is greater than or equal to a threshold value.

The determination results of a sudden downward leaning for turning and a sudden rise after completing the turn by the processor 110 as described above are stored in the memory 120 as data related to at least one of the frequency or degree. The frequency is, for example, the frequency of occurrence of the sudden downward leaning for turning or the sudden rises after completing the turn. The degree is, for example, the ratio of the magnitude of the time derivative value of the roll rate to the first sudden-turn threshold value in the case of the sudden downward leaning for turning, or the ratio of the magnitude of the time derivative value of the roll rate to the second sudden-turn threshold value in the case of the sudden rise after completing the turn.

The processor 110 may determine at least one of a sudden downward leaning for turning of the leaning vehicle X or a sudden rise after completing the turn of the leaning vehicle X based on, for example, the roll rate rather than the time derivative value of the roll rate.

3. Sudden Course Change

The processor 110 determines a sudden course change of the leaning vehicle X based on, for example, the roll rate. The processor 110 determines the sudden course change of the leaning vehicle X using the leaning-vehicle-traveling data stored in the memory 120.

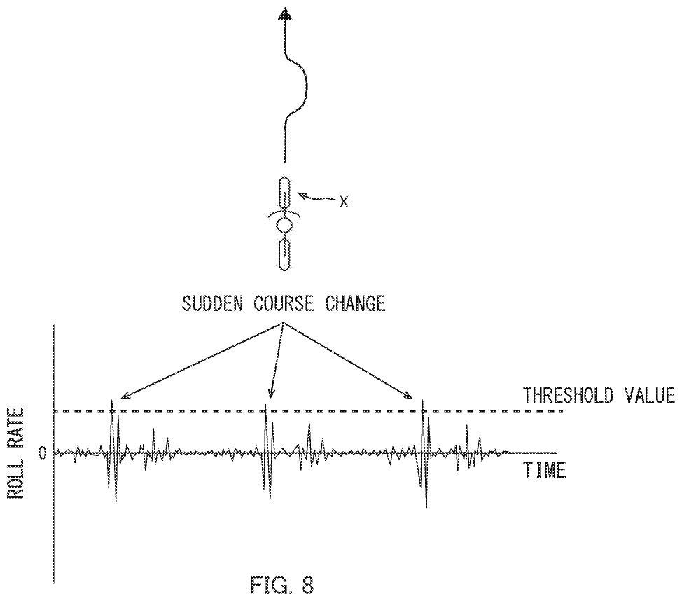

FIG. 8 is a view showing an example of a change in the roll rate of the leaning vehicle X during its travel. As shown in FIG. 8, the processor 110 determines that the leaning vehicle X has suddenly changed course when the peak value of the roll rate is greater than or equal to a threshold value. The threshold value is stored in the memory 120. The processor 110 may use a roll-axis angular acceleration, a yaw rate, a pitch axis acceleration, or a yaw-axis angular acceleration in place of the roll rate to determine the sudden course change. The processor 110 may determine the sudden course change when a difference between the peak values of the roll axis angular acceleration at both the times of a downward leaning and a rise of the vehicle body is greater than or equal to a threshold value.

The determination result of a sudden course change by the processor 110 as described above is stored in the memory 120 as data related to at least one of the frequency or degree. The frequency is, for example, the frequency of occurrence of the sudden course changes. The degree is, for example, the ratio of the magnitude of the peak value of the roll rate to the threshold value in the case of the sudden course change.

The processor 110 may use processed data of the peak value of the roll rate to determine the sudden course change of the leaning vehicle X.

The leaning-vehicle-traveling-data analyzer 112 analyzes each of the scenes described above and outputs the results. The economic-loss-related-data generator 113 generates economic-loss-related data using the determination result of each scene by the leaning-vehicle-traveling-data analyzer 112 and the economic-loss-related-data-generation model. The economic-loss-related-data-generation model includes, for example, data that associates each scene with economic-loss-related data. This allows the economic-loss-related-data generator 113 to generate the economic-loss-related data using the determination result of each scene and the economic-loss-related data-generation model. The output part 114 outputs the economic-loss-related data generated by the economic-loss-related-data generator 113.

With the above-described configuration, the processor 110 of the leaning-vehicle-traveling-data-processing device 101 uses leaning-vehicle-traveling data of the leaning vehicle X driven by a driver to analyze at least one of the scene of a sudden downward leaning for turning, the scene of a sudden rise after completing a turn, or the scene of a sudden course change, of the leaning vehicle X, and to thereby generate and output economic-loss-related data using the leaning-vehicle-traveling data and the economic-loss-related-data-generation model.

Thus, economic-loss-related data can be obtained using leaning-vehicle-traveling data that includes data related to at least one of a sudden downward leaning for turning, a sudden rise after completing a turn, or a sudden course change, of the leaning vehicle X. The leaning-vehicle-traveling data as described above is likely to show the driving skill and driving tendency of the driver driving the leaning vehicle X. Therefore, it is possible to obtain more accurate economic-loss-related data, reflecting the driving skill and driving tendency of the driver driving the leaning vehicle X.

Moreover, the levels of predictive driving of drivers differ according to the driving skills of the drivers of the leaning vehicle. Thus, the level of predictive driving of each driver is more likely to be shown in a sudden left or right leaning movement of the vehicle body. It is, therefore, possible to accurately obtain economic-loss-related data in accordance with the driver's level of predictive driving, by generating the economic-loss-related data in accordance with the sudden left or right leaning movement of the vehicle body as described above.

In the case where the first leaning-vehicle-traveling data is defined as leaning-vehicle-traveling data obtained when a driver travels the first route on the first leaning vehicle during the first time frame of the first date without a sudden acceleration or deceleration movement of the vehicle body in the front-rear direction or a sudden left or right leaning movement of the vehicle body, and the second leaning-vehicle-traveling data is defined as leaning-vehicle-traveling data obtained when the driver travels the first route on the first leaning vehicle during the first time frame of the first date without the sudden acceleration or deceleration movement of the vehicle body in the front-rear direction, but with the sudden left or right leaning movement of the vehicle body, the economic-loss-related-data-generation model is configured to generate economic-loss-related data in accordance with the sudden left or right leaning movement of the vehicle body based on data indicating left or right leaning movements of the vehicle body included in the leaning-vehicle-traveling data so that the first economic-loss-related data generated based on the first leaning-vehicle-traveling data and the second economic-loss-related data generated based on the second leaning-vehicle-traveling data differ from each other.

Furthermore, by analyzing at least one of the scene of a sudden downward leaning for turning, the scene of a sudden rise after completing a turn, or the scene of a sudden course change, of the leaning vehicle X, an increase in the amount of data to be processed is suppressed, compared with a case where all the traveling scenes are analyzed. This is conducive to reduction in hardware load on the leaning-vehicle-traveling-data-processing device 101. Therefore, design flexibility of hardware resources of the leaning-vehicle-traveling-data-processing device 101 can be enhanced.

In the manner described above, it is possible to provide the leaning-vehicle-traveling-data-processing device 101 that can enhance design flexibility of hardware resources, with increased accuracy of economic-loss-related data obtained based on leaning-vehicle-traveling data.

In this embodiment, the processor 110 analyzes at least one of the frequency or degree of at least one of a sudden downward leaning for turning, a sudden rise after completing a turn, or a sudden course change using leaning-vehicle-traveling data, and then generates and outputs economic-loss-related data in accordance with the analyzed scene using the leaning-vehicle-traveling data and the economic-loss-related-data-generation model so that the economic-loss-related data differs according to at least one of the frequency or degree described above.

The leaning-vehicle-traveling data and the economic-loss-related-data-generation model each include data more strongly indicating differences in driving skill and driving tendency of drivers driving the leaning vehicle X. Therefore, economic-loss-related data generated based on the leaning-vehicle-traveling data and the economic-loss-related-data-generation model better reflects each driver's driving skill and driving tendency. Accordingly, the leaning-vehicle-traveling-data-processing device 101 can generate and output the economic-loss-related data that reflects more reliably the driver's driving skill and driving tendency.

Moreover, the levels of predictive driving of drivers differ according to the drivers' driving skills of the leaning vehicle. Thus, the level of predictive driving of each driver is more likely to be shown in the leaning-vehicle-traveling data and the economic-loss-related-data-generation model. It is, therefore, possible to accurately obtain economic-loss-related data in accordance with the driver's level of predictive driving, by generating the economic-loss-related data based on the leaning-vehicle-traveling data and the economic-loss-related-data-generation model as described above.

Furthermore, the processor 110 analyzes at least one of the frequency or degree of at least one of the scene of a sudden downward leaning for turning, the scene of a sudden rise after completing a turn, or the scene of a sudden course change, which suppresses an increase in the amount of data to be processed, compared with a case where all the traveling scenes are analyzed. This is conducive to reduction in hardware load on the leaning-vehicle-traveling-data-processing device 101. Therefore, design flexibility of hardware resources of the leaning-vehicle-traveling-data-processing device 101 can be enhanced.

In the manner described above, it is possible to provide the leaning-vehicle-traveling-data-processing device 101 that can enhance design flexibility of hardware resources, with increased accuracy of economic-loss-related data obtained based on leaning-vehicle-traveling data.

### Fourth Embodiment

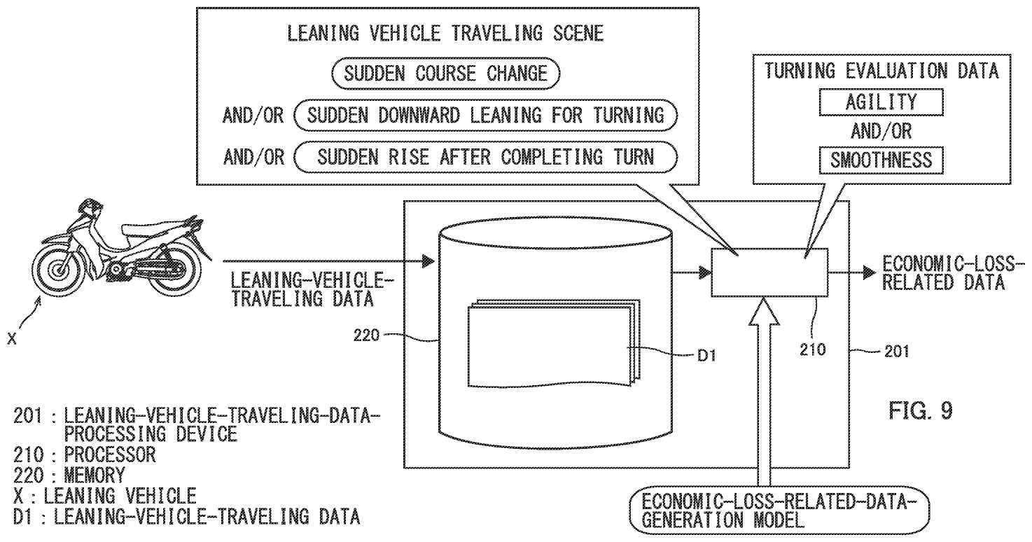

FIG. 9 is a view showing a schematic configuration of a leaning-vehicle-traveling-data-processing device 201 according to a fourth embodiment. The leaning-vehicle-traveling-data-processing device 201 of this embodiment analyzes a traveling scene of the leaning vehicle X based on leaning-vehicle-traveling data, and generates turning evaluation data related to at least one of agility or smoothness of the leaning vehicle X when turning, to thereby generate economic-loss-related data based on the leaning-vehicle-traveling data and the economic-loss-related-data-generation model as well as the turning evaluation data. In the following description, components similar to those of the third embodiment are denoted by the same reference characters and will not be described again, and only components different from those of the third embodiment will be described.

As in the processor 110 of the third embodiment, a processor 210 analyzes at least one of the scene of a sudden downward leaning for turning, the scene of a sudden rise after completing a turn, or the scene of a sudden course change, of the leaning vehicle X, using leaning-vehicle-traveling data and the economic-loss-related-data-generation model. The processor 210 generates turning evaluation data related to at least one of agility or smoothness of the leaning vehicle X when turning, based on the leaning-vehicle-traveling data. The processor 210 generates economic-loss-related data based on the analysis result of at least one scene described above, the turning evaluation data, and the economic-loss-related-data-generation model.

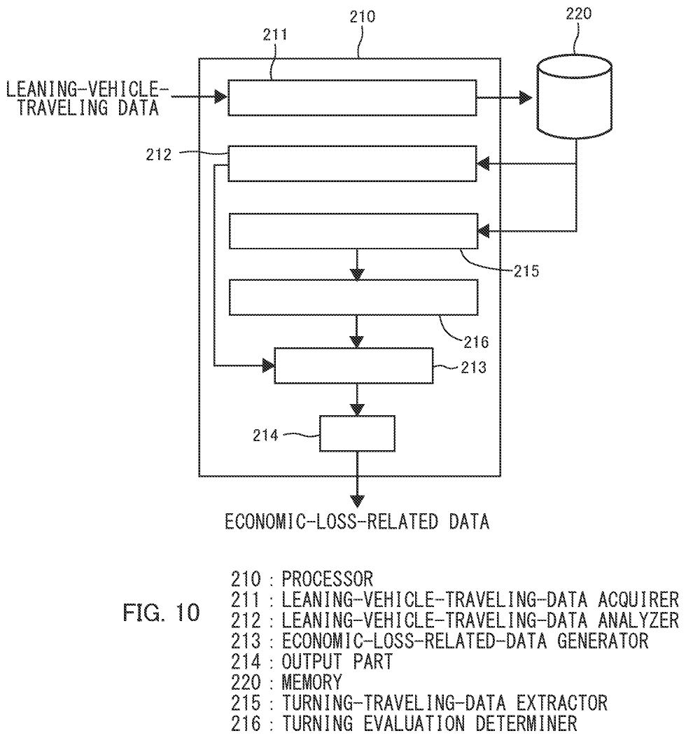

FIG. 10 is a view showing a schematic configuration of the processor 210. The processor 210 includes a leaning-vehicle-traveling-data acquirer 211, a leaning-vehicle-traveling-data analyzer 212, an economic-loss-related-data generator 213, an output part 214, a turning-traveling-data extractor 215, and a turning evaluation determiner 216.

The turning-traveling-data extractor 215 extracts traveling data of the leaning vehicle X when turning, from the leaning-vehicle-traveling data stored in a memory 220. One method of extracting the traveling data of the leaning vehicle X when turning from the leaning-vehicle-traveling data is, for example, to use a yaw rate of the leaning vehicle X. The method of extracting the traveling data of the leaning vehicle X when turning from the leaning-vehicle-traveling data is similar to the method disclosed in, for example, International Patent Publication No. 2021/079494.

Data related to other parameters, indicating a behavior of the leaning vehicle X, such as a pitch rate and a roll rate, data related to a driving input to the leaning vehicle X, and data related to a location of the leaning vehicle X, for example, may be used to extract traveling data of the leaning vehicle X when turning from leaning-vehicle-traveling data. A plurality of types of data may be combined to extract the traveling data of the leaning vehicle X when turning from the leaning-vehicle-traveling data.

The turning evaluation determiner 216 generates turning evaluation data related to at least one of agility or smoothness of the leaning vehicle X when turning, by using the turning traveling data extracted from the leaning-vehicle-traveling data by the turning-traveling-data extractor 215.

In detail, the turning evaluation determiner 216 determines the degree of agility using, for example, at least one low-frequency-band component of at least one of a roll angle or a pitch angle of the leaning vehicle X. The turning evaluation determiner 216 determines, for example, a roll determination index based on the low-frequency-band component of the roll angle, and evaluates the determined roll determination index to evaluate the agility. The roll determination index is an index that scores the agility. The degree of the agility is determined by the ratio of an agility score to an evaluation criterion.

The turning evaluation determiner 216 also determines the degree of smoothness using, for example, a yaw rate of the leaning vehicle X. The turning evaluation determiner 216 determines, for example, a yaw determination index based on the yaw rate, and evaluates the determined yaw determination index to evaluate the smoothness. The yaw determination index is an index that scores the smoothness. The degree of the smoothness is determined by the ratio of a smoothness score to an evaluation criterion.

The method of generating turning evaluation data related to agility and smoothness by the turning evaluation determiner 216 is similar to the method disclosed in International Patent Publication No. 2021/079494. International Patent Publication No. 2021/079494 describes the agility as an agile movement and the smoothness as a smooth movement.

The turning evaluation determiner 216 may generate turning evaluation data related to agility and smoothness, or may generate turning evaluation data related to agility or smoothness. The turning evaluation determiner 216 may generate turning evaluation data classified into four categories using the degree of agility and the degree of smoothness, as disclosed in International Patent Publication No. 2021/079494. The evaluation of each category in this case is disclosed in, for example, International Patent Publication No. 2021/079494.

The turning evaluation data obtained by the turning evaluation determiner 216 is stored in the memory 220.

The economic-loss-related-data generator 213 generates economic-loss-related data based on the analysis result of the leaning-vehicle-traveling-data analyzer 212, the turning evaluation result of the turning evaluation determiner 216 stored in the memory 220, and the economic-loss-related-data-generation model. That is, the economic-loss-related-data generator 213 generates economic-loss-related data based on the leaning-vehicle-traveling data and the economic-loss-related-data-generation model, as well as the turning evaluation data.

The economic-loss-related-data generator 213 may, for example, apply the analysis result of the leaning-vehicle-traveling data by the leaning-vehicle-traveling-data analyzer 212, and the turning evaluation result of the turning evaluation determiner 216 stored in the memory 220 to the economic-loss-related-data-generation model, to thereby generate economic-loss-related data.

The economic-loss-related-data generator 213 may generate economic-loss-related data, for example, using data obtained by applying the result of analysis of the leaning-vehicle-traveling data by the leaning-vehicle-traveling-data analyzer 212 to the economic-loss-related-data-generation model, as well as the turning evaluation result of the turning evaluation determiner 216 stored in the memory 220.

The configuration of the processor 210 other than that described above is similar to the configuration of the processor 110 in the third embodiment. The configuration of the memory 220 is similar to that of the memory 120 in the third embodiment.

As described above, in this embodiment, the processor 210 generates turning evaluation data related to at least one of agility or smoothness of the leaning vehicle X when turning, from leaning-vehicle-traveling data. The memory 220 stores the generated turning evaluation data. Economic-loss-related data is generated based on the leaning-vehicle-traveling data and the economic-loss-related-data-generation model, as well as the turning evaluation data related to at least one of agility or smoothness of the leaning vehicle X when turning.

This allows for generation of the economic-loss-related data based on the leaning-vehicle-traveling data and the economic-loss-related-data-generation model, as well as the turning evaluation data related to at least one of agility or smoothness of the leaning vehicle X when turning, so that output-data that better reflects a driving skill and driving tendency of a driver driving the leaning vehicle X can be obtained. Therefore, the leaning-vehicle-traveling-data-processing device 201 can generate and output output-data that reflects more reliably the driver's driving skill and driving tendency.

### Other Embodiments

The embodiments of the present teaching have been described above, but the above-described embodiments are merely illustrative examples of preferred embodiments of the present teaching. Therefore, the present teaching is not limited to the above-described embodiments and the above-described embodiments can be appropriately modified and implemented without departing from the gist of the teaching.

In the embodiments described above, leaning-vehicle-traveling data may include, for example, leaning-vehicle-driving-input data related to a driving input to the leaning vehicle by a driver, leaning-vehicle-behavior data related to a behavior of the leaning vehicle, leaning-vehicle-location data related to a traveling location of the leaning vehicle, and leaning-vehicle-traveling-environment data related to a traveling environment of traveling of the leaning vehicle, or may include other data. The leaning-vehicle-traveling data may include one or more of the leaning-vehicle-driving-input data, the leaning-vehicle-behavior data, the leaning-vehicle-location data, or the leaning-vehicle-traveling-environment data.

The leaning-vehicle-driving-input data is data related to an operation input of a driver that is performed when the driver drives the leaning vehicle. Specifically, the leaning-vehicle-driving-input data may include data related to, e.g., an accelerator operation, a brake operation, a gear-shift operation (clutch lever operation and shift pedal operation), steering, or a positional change of the center of gravity caused by a change in posture of the driver. Specifically, the leaning-vehicle-driving-input data may include data related to, e.g., operations of various switches such as a horn switch, a winker switch, and a lighting switch. The leaning-vehicle-driving-input data is data related to a driving input by the driver, and thus, better reflects a result of determination by the driver. In the leaning vehicle, there are a large number of types of operations by the driver, and flexibility in options by the driver during driving is high, so that the driver's driving skill and driving tendency tend to be strongly reflected. The leaning-vehicle-driving-input data may include processed data obtained by processing data acquired from, e.g., a sensor. The leaning-vehicle-driving-input data may include processed data obtained by processing data acquired from, e.g., the sensor with other data.

The leaning-vehicle-behavior data is data related to a behavior of the leaning vehicle caused by a driving input by a driver while the leaning vehicle is driven by the driver. Specifically, the leaning-vehicle-behavior data includes, for example, an acceleration, a speed, and an angle that vary when the driver drives the leaning vehicle. That is, the leaning-vehicle-behavior data is data showing a behavior of the leaning vehicle occurring in cases such as where the driver performs an accelerator operation, a brake operation or a gear-shift operation to accelerate or decelerate the leaning vehicle, or where steering of the leaning vehicle or a posture change including a positional change of the center of gravity is performed.

The leaning-vehicle-behavior data may include not only the data related to an acceleration, speed, and angle of the leaning vehicle as described above, but also an operation occurring in the leaning vehicle caused by, e.g., a switch operation performed on the leaning vehicle by the driver. That is, the leaning-vehicle-behavior data includes data related to operations occurring in the leaning vehicle caused by operations of various switches such as a horn switch, a winker switch, and a lighting switch. The leaning-vehicle-behavior data strongly reflects a result of a driving input by the driver. Thus, the leaning-vehicle-behavior data also tends to strongly reflect the driver's driving skill and driving tendency. The leaning-vehicle-behavior data may include processed data obtained by processing data acquired from, e.g., a sensor. The leaning-vehicle-behavior data may include processed data obtained by processing data acquired from, e.g., the sensor with other data.

The leaning-vehicle-location data is data related to a traveling location of the leaning vehicle. For example, the leaning-vehicle-location data can be detected based on information from a GPS, or a communication base station of a communication mobile terminal. The leaning-vehicle-location data can be determined by, e.g., various positioning techniques or a SLAM. The leaning-vehicle-location data strongly reflects a result of a driving input of a driver that strongly reflects the driver's driving skill and driving tendency. Thus, the leaning-vehicle-location data also tends to strongly reflect the driver's driving skill and driving tendency. The leaning-vehicle-location data may include processed data obtained by processing data acquired from, e.g., a sensor. The leaning-vehicle-location data may include processed data obtained by processing data acquired from, e.g., the sensor with other data.

The leaning-vehicle-traveling-environment data includes map data, for example. The map data may be associated with, for example, information on road situations, information on road traffic environments such as signals and facilities, and regulation information on traveling on roads. The map data may be associated with environmental data such as weather, temperature, and humidity. The leaning-vehicle-traveling-environment data can be used for analyzing a driver's driving skill and driving tendency, together with the leaning-vehicle-driving-input data, the leaning-vehicle-behavior data, and the leaning-vehicle-location data.

The information on road situations includes information on roads (areas) under crowded conditions, such as a condition in which traffic congestion frequently occurs and a condition in which many vehicles are parked on streets. Accuracy of the information increases when being combined with time frames. The information on road situations includes information on roads that easily flood upon squalls.

The leaning-vehicle-traveling-environment data may include processed data obtained by processing data acquired from, e.g., a sensor. The leaning-vehicle-traveling-environment data may include processed data obtained by processing data acquired from, e.g., the sensor with other data.

The leaning-vehicle-traveling-environment data is considered to be an example of stress on the driver from the outside. The leaning-vehicle-traveling-environment data affects determination of the driver. The leaning-vehicle-traveling-environment data affects driving of the driver. Thus, with the use of the leaning-vehicle-traveling-environment data, leaning-vehicle-traveling data is likely to more strongly show the driver's driving skill and driving tendency. Furthermore, the use of the leaning-vehicle-traveling-environment data affects the purpose of use and frequency of use of the leaning vehicle, so that the leaning-vehicle-traveling data is likely to strongly show the driver's driving skill and driving tendency.

The leaning-vehicle-traveling-environment data can be acquired by various configurations. The configuration for acquiring the leaning-vehicle-traveling-environment data is not limited to a specific configuration. For example, the configuration for acquiring the leaning-vehicle-traveling-environment data is an external-environment-recognition device mounted on the leaning vehicle. More specifically, the configuration for acquiring the leaning-vehicle-traveling-environment data is, e.g., a camera or a radar. Alternatively, the configuration for acquiring the leaning-vehicle-traveling-environment data is a communication device. More specifically, the configuration for acquiring the leaning-vehicle-traveling-environment data is a vehicle-to-vehicle communication device or a road-to-vehicle communication device. The leaning-vehicle-traveling-environment data can also be obtained through the Internet, for example.

In the embodiments described above, the leaning-vehicle-traveling data may include data related to sudden acceleration of the leaning vehicle, and data related to sudden deceleration of the leaning vehicle.

Unlike a four-wheeled vehicle, brakes of a leaning vehicle include a front wheel brake operator that operates a front wheel brake and a rear wheel brake operator that operates a rear wheel brake. Thus, in the leaning vehicle, a driver must adjust braking force of both the front and rear wheel brakes. In such a leaning vehicle, differences in driving skill and driving tendency of drivers are likely to be shown in a deceleration of the leaning vehicle. Therefore, a correlation between the driver operating the leaning vehicle and economic loss is easily obtained from data related to a deceleration of the leaning vehicle.

In addition, the weight of a leaning vehicle is generally lighter than the weight of a four-wheeled vehicle. Thus, in the leaning vehicle, the state of operation of an accelerator operator by a driver is likely to be reflected in acceleration. Therefore, differences in driving skill and driving tendency of drivers are likely to be shown in an acceleration of the leaning vehicle. Accordingly, a correlation between the driver operating the leaning vehicle and economic loss is easily obtained from data related to an acceleration of the leaning vehicle.

In the embodiments described above, economic-loss-related data output from the leaning-vehicle-traveling-data-processing device 1, 101, 201 is used for the economic loss related services. Alternatively, the economic-loss-related data output from the leaning-vehicle-traveling-data-processing device may be used in combination with data related to other information. For example, the economic-loss-related data may be used in combination with data related to information such as theft prevention of the leaning vehicle, abnormalities of the leaning vehicle, breakdowns of the leaning vehicle, maintenance of the leaning vehicle, collision prevention, improvement of traveling environment, course guidance, and information presentation to a driver.

In the embodiments described above, the leaning-vehicle-traveling-data-processing device 1, 101, 201 generates economic-loss-related data based on leaning-vehicle-traveling data using the economic-loss-related data-generation model. The economic-loss-related-data-generation model may generate the economic-loss-related data using a proportion of sudden left or right leaning movements of the vehicle body in the leaning-vehicle-traveling data. The economic-loss-related-data-generation model may generate the economic-loss-related data using a proportion of less sudden left or right leaning movements of the vehicle body in the leaning-vehicle-traveling data.

In the first embodiment described above, leaning-vehicle-traveling data is stored in the memory 20. Alternatively, the leaning-vehicle-traveling data may be acquired by a leaning-vehicle-traveling-data acquirer provided in the processor. In this case, the leaning-vehicle-traveling-data acquirer may acquire the leaning-vehicle-traveling data through a sensor. The acquired leaning-vehicle-traveling data may be stored in the memory.

In the second embodiment described above, the leaning-vehicle-traveling data, the first leaning-vehicle-traveling data, and the second leaning-vehicle-traveling data all include data for one driving cycle or more, respectively. Alternatively, at least one of the leaning-vehicle-traveling data, the first leaning-vehicle-traveling data, or the second leaning-vehicle-traveling data may include data for less than one driving cycle.

In the second embodiment described above, the economic-loss-related-data-generation model is configured to generate economic-loss-related data in accordance with a sudden left or right leaning movement of the vehicle body, based on data for one driving cycle or more that indicate left or right leaning movements of the vehicle body and are included in the leaning-vehicle-traveling data so that the first economic-loss-related data generated based on the first leaning-vehicle-traveling data and the second economic-loss-related data generated based on the second leaning-vehicle-traveling data differ from each other. Alternatively, the economic-loss-related-data-generation model may be configured to generate economic-loss-related data in accordance with a sudden left or right leaning movement of the vehicle body, based on data for less than one driving cycle that indicate left or right leaning movements of the vehicle body and are included in the leaning-vehicle-traveling data.

In the second embodiment described above, the leaning-vehicle-traveling data processed by the processor 10 of the leaning-vehicle-traveling-data-processing device 1 includes traveling data for one driving cycle or more of the leaning vehicle X. Similarly, in the first embodiment, the leaning-vehicle-traveling data processed by the processor 10 of the leaning-vehicle-traveling-data-processing device 1 may include traveling data for one driving cycle or more of the leaning vehicle X, or may include traveling data for less than one driving cycle.

In the third embodiment described above, the processor 110 of the leaning-vehicle-traveling-data-processing device 101 analyzes at least one of the frequency or degree of at least one of a sudden downward leaning for turning, a sudden rise after completing a turn, or a sudden course change using leaning-vehicle-traveling data, and then generates and outputs economic-loss-related data in accordance with the analyzed scene using the economic-loss-related-data-generation model so that the economic-loss-related data differs according to at least one of the frequency or degree described above.

Alternatively, the processor may analyze a parameter other than the frequency and degree, and then generate and output economic-loss-related data in accordance with the analyzed scene so that the parameter differs.

In the third embodiment described above, the leaning-vehicle-traveling-data-processing device 101 analyzes at least one of the scene of a sudden downward leaning for turning, the scene of a sudden rise after completing a turn, or the scene of a sudden course change, and then generates and outputs economic-loss-related data. Alternatively, the leaning-vehicle-traveling-data-processing device may analyze leaning-vehicle-traveling data in combination with other data to generate economic-loss-related data.

In the third embodiment described above, the processor 110 includes the leaning-vehicle-traveling-data acquirer 111. Alternatively, the processor may be free of the leaning-vehicle-traveling-data acquirer. In this case, the processor may read leaning-vehicle-traveling data stored in the memory.

In the fourth embodiment, the leaning-vehicle-traveling-data-processing device 201 analyzes the traveling scenes of the leaning vehicle X from leaning-vehicle-traveling data, and also generates turning evaluation data related to at least one of agility or smoothness of the leaning vehicle X when turning, to thereby generate economic-loss-related data based on the leaning-vehicle-traveling data and the economic-loss-related-data-generation model as well as the turning evaluation data. Alternatively, the leaning-vehicle-traveling-data-processing device may generate economic-loss-related data based on the leaning-vehicle-traveling data, the economic-loss-related-data-generation model, and the turning evaluation data without analyzing the traveling scenes of the leaning vehicle X.

### REFERENCE SIGNS LIST

1, 101, 201 leaning-vehicle-traveling-data-processing device
10, 110, 210 processor
111 leaning-vehicle-traveling-data acquirer
112, 212 leaning-vehicle-traveling-data analyzer
11, 113, 213 economic-loss-related-data generator
12, 114, 214 output part
20, 120, 220 memory
215 turning-traveling-data extractor
216 turning evaluation determiner
D1 leaning-vehicle-traveling data
X leaning vehicle

1. A leaning-vehicle-traveling-data-processing device for processing leaning-vehicle-traveling data that is traveling data of a leaning vehicle configured to lean to left when turning to the left and lean to right when turning to the right, the leaning-vehicle-traveling-data-processing device comprising:
a non-transitory memory configured to store the leaning-vehicle-traveling data; and
a processor configured to generate economic-loss-related data based on the leaning-vehicle-traveling data stored in the memory by using an economic-loss-related-data-generation model, to thereby output the generated economic-loss-related data, wherein
the economic-loss-related-data-generation model is configured to generate the economic-loss-related data in accordance with data indicating a sudden movement of a vehicle body of the leaning vehicle included in the leaning-vehicle-traveling data, wherein
first leaning-vehicle-traveling data is obtained when a driver travels a first route on a first leaning vehicle during a first time frame of a first date without sudden acceleration or deceleration movement of the vehicle body in a front-rear direction of the leaning vehicle or the sudden left or right leaning movement of the vehicle body,
second leaning-vehicle-traveling data is obtained when the driver travels the first route on the first leaning vehicle during the first time frame of the first date without the sudden acceleration or deceleration movement of the vehicle body in the front-rear direction, but with the sudden left or right leaning movement of the vehicle body, and
the economic-loss-related-data-generation model is configured to generate the economic-loss-related data in accordance with the sudden left or right leaning movement of the vehicle body based on data indicating left or right leaning movements of the vehicle body included in the leaning-vehicle-traveling data so that first economic-loss-related data generated based on the first leaning-vehicle-traveling data and second economic-loss-related data generated based on the second leaning-vehicle-traveling data differ from each other.

2. The leaning-vehicle-traveling-data-processing device according to claim 1, wherein
the data that indicates the left or right leaning movement of the vehicle body, and that is used by the economic-loss-related-data-generation model to generate the economic-loss-related data, is for at least one driving cycle, wherein
one driving cycle is a period of time during which a posture, and a speed in the front-rear direction, of the leaning vehicle change from a predetermined state and then return to the predetermined state, and
each of the first leaning-vehicle-traveling data and the second leaning-vehicle-traveling data is for at least one driving cycle.

3. The leaning-vehicle-traveling-data-processing device according to claim 1, wherein each of the first leaning-vehicle-traveling data and the second leaning-vehicle-traveling data includes at least data related to a roll motion of the vehicle body.

4. The leaning-vehicle-traveling-data-processing device according to claim 1, wherein during the sudden left or right leaning movement of the vehicle body, the data indicating the left or right leaning movement of the vehicle body included in the leaning-vehicle-traveling data is greater than a threshold value.

5. The leaning-vehicle-traveling-data-processing device according to claim 1, wherein the sudden left or right leaning movement of the vehicle body includes at least one of a sudden downward leaning for turning, a sudden rise after completing a turn, or a sudden course change, of the leaning vehicle.

6. The leaning-vehicle-traveling-data-processing device according to claim 1, wherein
the processor is further configured to generate turning evaluation data related to at least one of agility or smoothness of the leaning vehicle when turning, from the leaning-vehicle-traveling data,
the memory is further configured to store the generated turning evaluation data, and
the economic-loss-related data is generated based on the leaning-vehicle-traveling data, the economic-loss-related-data-generation model, and the generated turning evaluation data.
